(19) United States
(12) Patent Application Publication
(10) Pub. No.: US 2012/0268379 A1
(43) Pub. Date: Oct. 25, 2012

(54) ILLUMINATED KEY SHEET

(76) Inventors: Toshikazu Yoshioka, Kita-ku (JP); Yasunori Takeda, Kita-ku (JP)

(21) Appl. No.: 13/518,784

(22) PCT Filed: Nov. 29, 2010
(86) PCT No.: PCT/JP2010/071239

§ 371 Date: Jun. 22, 2012

(30) Foreign Application Priority Data
Dec. 28, 2009 (JP) 2009-298121

(51) Int. Cl. G06F 3/02

(52) U.S. Cl. 345/168

(57) ABSTRACT

To provide a technique which involves a key sheet integrally including a light guide sheet and having a plurality of illumination areas, the technique preventing light leakage from the boundary between the individual illumination areas and providing high durability against a repeated pressing operation. A mask layers cover the opening edges of slits of a light guide sheet on the operation surface side. The mask layers can prevent emission of light from the openings of the slits to the outside, the light having leaked from the end faces of the light guide sheet, and the end faces forming the slits. A front sheet and a back side cover can enhance the durability of a base sheet, the front sheet adhering to the light guide sheet so as to cover the slits.

### TECHNICAL FIELD

The present invention relates to an illuminated key sheet which serves as an input member used for portable terminals, such as cell phones, PDAs, and portable music players, and various types of electronic equipment such as AV equipment.

### BACKGROUND ART

Various types of electronic equipment, for example, portable terminals and AV equipment, have an input member such as a push-button switch for an input, the push-button switch having a configuration in which a key sheet with push buttons (key tops) overlies a circuit board on which a contact switch is disposed. An illuminated key sheet utilizes an internal light source provided in electronic equipment to illuminate the key sheet from the back side, and use of the illuminated key sheet therefore enhances operability even in a dark place.

In most cases, the illuminated key sheet has a light guide sheet to increase the efficiency of light guiding, which enables the small number of light sources to uniformly illuminate the entire key sheet with brightness. In order to divide the illuminated key sheet into a plurality of illumination areas, a light guide sheet which enables illumination to be controlled in each illumination area has been proposed. For instance, Japanese Unexamined Patent Application Publication No. 2009-54390 (Patent Literature 1) discloses a technique in which a slit formed in a light guide sheet serves for light shielding and defines a plurality of illumination areas and in which illumination can be controlled in each illumination area. Furthermore, Japanese Unexamined Patent Application Publication Nos. 2008-41431 (Patent Literature 2) and 2009-187855 (Patent Literature 3) each disclose a technique in which a light-shielding resin fills a slit formed at the boundary between individual illumination areas to suppress the occurrence of light leakage between the illumination areas.

### CITATION LIST

### Patent Literature

PTL 1: Japanese Unexamined Patent Application Publication No. 2009-54390
PTL 2: Japanese Unexamined Patent Application Publication No. 2008-41431
PTL 3: Japanese Unexamined Patent Application Publication No. 2009-187855

### SUMMARY OF INVENTION

### Technical Problem

The technique disclosed in Patent Literature 1 can control the illumination in each illumination area. In contrast, since the slit is formed between the individual key tops, light which has reached the end face of the slit is emitted from the light guide sheet with the result that the light problematically leaks between the key tops. In the techniques disclosed in Patent Literatures 2 and 3, the light-shielding resin put into the slit can prevent emission of light from the edge face of the slit. In the case of repeatedly deforming the light guide sheet by a pressing operation, unfortunately, the light-shielding resin peels from the light guide sheet with the result that the end face of the slit is exposed. Light emitted from the end face therefore problematically leaks between the key tops.

The study of the invention has been made in view of these technical backgrounds. It is an object of the invention to provide a technique which involves a key sheet integrally including a light guide sheet and having a plurality of illumination areas, the technique preventing light leakage from the boundary between the individual illumination areas and providing high durability against a repeated pressing operation.

### Solution to Problem

In view of the above object, an aspect of the invention has the following configurations.

According to a first aspect of the invention, there is provided an illuminated key sheet including a flexible base sheet and a plurality of depressing operation portions formed on the flexible base sheet, wherein the base sheet includes a light guide sheet having a slit and a plurality of illumination areas defined by the slit, and the base sheet has a mask layer and a reinforcement, the mask layer at least covering the opening edge of the slit on the operation surface side of the light guide sheet to prevent light leakage from the slit to the operation surface side, and the reinforcement adhering to the light guide sheet to cover the slit.

In this aspect of the invention, the base sheet includes the light guide sheet. Since light is transmitted inside the light guide sheet, the base sheet including the light guide sheet can efficiently transmit the light in the surface direction of the base sheet. The light guide sheet has the slit and the illumination areas defined by the slit. Since the light guide sheet has the slit, the slit can stop the transmission of light. The slit can therefore serve to form the illumination areas in the light guide sheet. The slit defines the illumination areas, which can prevent transmission of light from one illumination area to another illumination area. Guiding light from different light sources to the respective illumination areas for illumination enables the illumination to be independently controlled in the individual illumination areas.

The base sheet has the mask layer and the reinforcement, the mask layer covering the opening edge of the slit on the operation surface side of the light guide sheet to prevent light leakage from the slit to the operation surface side, and the reinforcement adhering to the light guide sheet to cover the slit.

The mask layer provided on the operation surface side of the light guide sheet at least covers the opening edge of the slit on the operation surface side of the light guide sheet. Although the mask layer may entirely cover the opening of the slit, the mask layer at least covers the opening edge of the slit, thereby being able to prevent light leakage from the opening of the slit to the operation surface side. Light initially leaks through the end face of the light guide sheet, which is the end face of the slit, and then reaches the opening of the slit with the result that the light leaks from the opening of the slit. Thus, covering the opening edge of the slit is the most effective to prevent light leakage, the opening edge continuing into the end face of the slit.

Since the reinforcement adheres to the light guide sheet so as to cover the slit, pressing force which concentrates on the vicinity of the slit in the pressing operation can be dispersed to the reinforcement, which can prevent the vicinity of the slit from being unnaturally deformed. The end face of the light guide sheet is therefore less likely to peel from the mask layer adhering to the end face of the light guide sheet inside the slit, so that the base sheet can have increased durability. The illuminated key sheet with high durability can be accordingly provided.

The base sheet may have an end face cover at least partially covering the end face of the light guide sheet and has a light-shielding print layer provided to the back side of the light guide sheet to prevent light from entering the light guide sheet, the end face forming the slit, and the back side being opposite to the operation surface side.

The end face cover of the base sheet can reduce light leakage from the end face of the slit, namely, the end face of the light guide sheet, leading to definitely suppressing the occurrence of the light leakage from one illumination area to another illumination area.

The light-shielding print layer may be formed to the back side of the light guide sheet of the base sheet. All light emitted from an internal light source for illumination of the illuminated key sheet does not enter the light guide sheet. Some of the light is emitted between the illuminated key sheet and a circuit board. Such light is diffusely reflected inside electronic equipment. The light then enters the light guide sheet from the back side thereof and passes through the light guide sheet in the thickness direction thereof. This light may cause unnecessary illumination of an illumination area adjacent to another illumination area which is under illumination or may cause illuminate of part of the base sheet which is not the depressing operation portion. However, the light-shielding print layer provided to the back side of the light guide sheet can prevent the diffusely reflected light from entering the light guide sheet from the back side thereof, which can prevent the light which has passed through the light guide sheet in the thickness direction thereof from causing unnecessary illumination of the illumination area and from leaking.

In the case of directly forming the light-shielding print layer on the back surface of the light guide sheet, the interface between the back surface of the light guide sheet and the light-shielding print layer is preferably in the form of a smooth surface. Since the smooth surface reflects light with high reflectance, the light transmitted inside the light guide sheet can be prevented from leaking from the light guide sheet. Entrance of the light to the light-shielding print layer is therefore excluded, leading to the increase in the efficiency of the light guiding.

The mask layer may have a color the same as that of the light-shielding print layer. Viewing the illuminated key sheet from the operation surface side, the boundary between the mask layer, which is formed on the operation surface side of the light guide sheet, and the light-shielding print layer, which is provided to the back side of the light guide sheet, is therefore less likely to be visually observed, which enables the mask layer and the light-shielding print layer to appear as the same layer. The mask layer formed so as to cover the slit enables the slit not to be visually observed, leading to hiding the segments of the illumination areas. The segments of the illumination areas can be accordingly prevented from appearing, thereby being able to improve designability.

The reinforcement may include a front sheet which adheres to the operation surface side of the light guide sheet, and the mask layer may be formed on the front sheet. This configuration refers to that the reinforcement may be the front sheet itself which adheres to the operation surface side of the light guide sheet and may also include the combination of the front sheet with another member. By virtue of this configuration, since the front sheet continuously covers the illumination areas, pressing force which concentrates on the vicinity of the slit in the pressing operation can be dispersed to the front sheet, which can prevent the vicinity of the slit from being unnaturally deformed. The end face of the light guide sheet inside the slit is therefore less likely to peel from the mask layer adhering to the end face of the light guide sheet or from the end face cover, which can impart enhanced durability to the base sheet. The illuminated key sheet with high durability can be accordingly provided.

Although light may be scattered by the damaged surface of the light guide sheet and then leak, the front sheet which covers the light guide sheet can prevent the light guide sheet from being damaged, which can prevent the decrease in the efficiency of the light guiding due to the damage of the light guide sheet.

The front sheet may be made from a flexible resin film. Since the flexible front sheet can be easily bent, the increase of pressing load can be prevented in the pressing operation even though the front sheet covers the plurality of illumination areas. In the case of pressing a contact switch having a click load, a tactile feel is therefore easily provided, leading to enhanced pressing operability. The front sheet made from the flexible resin film can be prevented from being elongated to an unnatural extent while being bent with ease. The occurrence of the flexible deformation to an unnatural extent can be therefore prevented in the vicinity of the slit. The end face of the light guide sheet inside the slit is accordingly less likely to peel from the mask layer adhering to the end face of the light guide sheet or from the end face cover, which can impart increased durability to the base sheet.

The flexible resin film can prevent the key sheet from being damaged and cracked by repeated deformation of the key sheet in the pressing operation, which can impart increased durability to the base sheet.

Resin films which can be bonded to the front sheet by thermocompression may be used for the light guide sheet. Use of the resin films, which can be bonded to the front sheet by thermocompression, for the light guide sheet enables the front sheet to be compressively bonded to the light guide sheet with ease for integration. In addition, since the mask layer and a display layer can be preliminarily formed by printing on the front sheet, the compression-bonding of the light guide sheet to the front sheet enables the mask layer and the display layer to be simultaneously formed on the light guide sheet. Forming the mask layer by using resins which can be subjected to hot-melt bonding eliminates use of an additional adhesive layer for the compression-bonding of the front sheet to the light guide sheet, leading to easy production of the base sheet at low costs.

The mask layer may extend to part of the end face of the light guide sheet, the end face forming the slit. In particular, part of the mask layer can function as the end face cover. By virtue of this configuration, the mask layer can partially cover the end face of the light guide sheet inside the slit, thereby being able to reduce light emission from the end face of the slit. Light can be therefore prevented from leaking at the boundary between the individual illumination areas. The mask layer which functions as the end face cover eliminates formation of an additional end face cover, leading to easy production of the base sheet at low costs.

The mask layer which extends to half of the end face of the slit can reduce the light emission by half. The mask layer which extends so as to substantially cover the entire end face of the slit substantially eliminates light emission.

The reinforcement may include a back side cover provided to the back side of the light guide sheet.

This configuration refers to that the reinforcement may be the back side cover which provided to the back side of the light guide sheet and may also include combination of the back side cover and another member.

In this configuration, the back side cover connects the illumination areas from the back side of the light guide sheet to impart an integrated structure to the illumination sheet, leading to easy production of the base sheet at low costs. The back side cover covers the slit from the back side of the light guide sheet to form the integrated structure. The occurrence of the flexible deformation to an unnatural extent can be therefore prevented in the vicinity of the slit. The end face of the light guide sheet inside the slit is accordingly less likely to peel from the mask layer adhering to the end face of the light guide sheet or from the end face cover, so that the base sheet can have increased durability.

As described above, the reinforcement may be formed by the front sheet, the back side cover, and combination of the front sheet and the back side cover.

The reinforcement may include the front sheet attached to the operation surface side of the light guide sheet and include the back side cover provided to the back side of the light guide sheet, and the front sheet adheres to the back side cover inside the slit, the front sheet and the back side cover being formed by using a resin film. In this configuration, since the light guide sheet is disposed between the front sheet and back side cover which adhere to each other, the front sheet and the back side cover are less likely to peel from the light guide sheet, which can enhance the durability of the base sheet. The front sheet and the back side cover are formed by using a resin film and can therefore have the same strength. The front sheet and back side cover formed by using the same resin film can be uniformly integrated with the light guide sheet from the two sides of the light guide sheet. The base sheet is not therefore bent by the temperature change even though a resin film having a linear expansion coefficient largely different from that in the light guide sheet is used, thereby being able to provide an illuminated key sheet used for wide application.

The configuration in which the front sheet adheres to the back side cover inside the slit includes a configuration in which the front sheet directly adheres to the back side cover and includes a configuration in which the front sheet indirectly adheres to the back side cover, for example, a configuration in which the front sheet adheres to the back side cover through either or both of the mask layer and light-shielding print layer.

In the illuminated key sheet having the back side cover, the back side cover may adhere to the plurality of the illumination areas of the light guide sheet and extend so as to entirely cover the back side of the illumination areas. This configuration can prevent the damage of the light-shielding print layer provided to the back side of the light guide sheet, thereby being able to prevent the damaged portion of the light-shielding print layer from causing light leakage.

A resin film used for the back side cover can prevent the back side cover from being damaged, so that the back side cover can have enhanced durability. Preliminary print formation of the light-shielding print layer which can be hot-melt bonded to the back side cover eliminates use of an additional adhesive layer for thermocompression-bonding of the light guide sheet to the back side cover, leading to easy production of the base sheet at low costs. In the case where the light-shielding print layer is formed on the back side cover made from a resin film and where the back side cover enters the inside of the slit with the result that the light-shielding print layer partially functions as the end face cover, part of the mask layer and light-shielding print layer can cover the substantially entire end face of the light guide sheet inside the slit, which can prevent light leakage from the end face of the slit. Light can be therefore definitely prevented from leaking from one illumination area to another illumination area. In addition, the light guide sheet is interposed between the front sheet and the back side cover individually provided to the two sides thereof, which can enhance the durability of the base sheet.

In the illuminated key sheet having the back side cover, the back side cover may be a reinforcing frame that suppresses a warp of the base sheet. The reinforcing frame which suppresses the warp of the base sheet is preferably made from hard resins or metal having high rigidity. By virtue of this configuration, the reinforcing frame can maintain the shape of the slit, thereby being able to provide an illuminated key sheet which is less likely to be bent. For example, also in the case where an illuminated key sheet having the reinforcing frame is provide to a housing which has an operation opening without a dividing frame, the shape of the slit can be maintained, leading to accurate press operation.

Since the shape of the slit can be maintained, the extension of the mask layer to the end face of the slit can prevent the mask layer from peeling from the end face of the slit. Light can be therefore prevented from leaking from the end face of the slit while the base sheet has enhanced durability. Light can be accordingly definitely prevented from leaking from one illumination area to another illumination area.

In the case where the reinforcing frame is provided only at the position corresponding to the slit which defines the illumination areas, the reinforcing frame can suppress the increase of the pressing load regardless of projection positions of the depressing operation portions, thereby being able to maintain good press operation feeling.

The reinforcing frame may be disposed inside the slit. In the case where the reinforcing frame is provided inside the slit, the reinforcing frame can maintain the shape of the slit, thereby being able to provide an illuminated key sheet which is less likely to be bent. For example, also in the case where an illuminated key sheet having the reinforcing frame disposed inside the slit is provide to a housing which has an operation opening without a dividing frame, the shape of the slit can be maintained, leading to accurate press operation.

The reinforcing frame made from light-shielding materials can prevent light leakage from the end face of the slit, which can definitely prevent light leakage from one illumination area to another illumination area.

In the case of using materials having high reflectance, such as metal, for the reinforcing frame, the reinforcing frame can reflect light which leaks from one illumination area through the slit and then return the light to the illumination area. The decrease of brightness caused by the light leakage from the slit can be therefore suppressed, leading to enhancement of the brightness of the illumination.

The reinforcing frame is disposed within the thickness of the light guide sheet, which can eliminate the increase in the thickness of the illuminated key sheet. A thin illuminated key sheet can be provided while having the reinforcing frame.

In the illuminated key sheet having the back side cover, the back side cover may have a solid penetration protrusion as the end face cover, the solid penetration protrusion filling the slit. Owing to this configuration, the penetration protrusion can cover the end face of the light guide sheet inside the slit, which can prevent light leakage from the end face of the slit. Since the penetration protrusion fills the slit formed between the adjacent illumination areas, the penetration protrusion definitely attenuate light, thereby being able to prevent light leakage from one illumination area to another illumination area.

In the case of using flexible resins for the back side cover having the solid penetration protrusion as the end face cover, the back side cover can be deformed in synchronism with the deformation of the light guide sheet and slit in the pressing operation, which can prevent formation of the gap between the penetration protrusion and the light guide sheet. Light can be therefore prevented from leaking from the end face of the slit while the base sheet has enhanced durability. In the case of using light-shielding resins for the back side cover having the solid penetration protrusion as the end face cover, the light-shielding back side cover can prevent light diffusely reflected inside electronic equipment from entering the back side of the light guide sheet, which can prevent light which has passed through the light guide sheet in the thickness direction thereof from causing unnecessary illumination of the illumination area and from leaking. In addition, the light-shielding penetration protrusion can definitely prevent light leakage from one illumination area to another illumination area.

In the illuminated key sheet, the end face cover may entirely cover the end face of the light guide sheet, the end face forming the slit. This configuration substantially eliminates emission of light from the end face of the slit, thereby being able to prevent light leakage from the inside of the slit. Light can be therefore prevented from leaking from one illumination area to another illumination area. For instance, the back side cover may deeply enter the inside of the slit and adhere thereto, or the mask layer and the back side cover may enter the inside of the slit in the same depth and adhere thereto. In the case of using a resin film for the back side cover and mask layer, the back side cover and mask layer have the same strength, which enables the back side cover and mask layer to be easily deformed in the same process and enables the end face of the slit to be easily covered.

According to a second aspect of the invention, there is provided an illuminated key sheet including a flexible base sheet and a plurality of depressing operation portions formed on the flexible base sheet, wherein the base sheet includes a light guide sheet having a slit and a plurality of illumination areas defined by the slit, and the base sheet has a mask layer at least covering the opening edge of the slit on the operation surface side of the light guide sheet to prevent light leakage from the slit to the operation surface side, the operation surface side being the side of the depressing operation portion.

In the illuminated key sheet of the second aspect, the base sheet includes the light guide sheet having the slit and the illumination areas defined by the slit. Since the light guide sheet easily transmits light in the surface direction thereof, the base sheet having the light guide sheet can efficiently transmit light in the surface direction of the base sheet.

The light guide sheet has the slit and the illumination areas defined by the slit. Since the light guide sheet has the slit, the slit can stop the transmission of light. The illumination areas are defined by the slit, which can prevent light leakage from one illumination area to another illumination area. Guiding light from different light sources to the respective illumination areas for illumination enables the illumination to be independently controlled in the individual illumination areas.

The base sheet has the mask layer covering the opening edge of the slit on the operation surface side of the light guide sheet to prevent light leakage from the slit to the operation surface side. In particular, the mask layer at least covers the opening edge of the slit on the operation surface side of the light guide sheet. Although the slit may entirely cover the opening, the slit at least covers the opening edge of the slit, thereby being able to prevent light leakage from the opening of the slit to the operation surface side. Light initially leaks through the end face of the light guide sheet, which is the end face of the slit, and then reaches the opening of the slit with the result that the light leaks from the opening of the slit. Thus, covering the opening edge of the slit is the most effective to prevent light leakage, the opening edge continuing into the end face of the slit.

The mask layer may extend to the slit-side end face of the light guide sheet. In other words, part of the mask layer may function as the end face cover. In this configuration, the mask layer can cover the slit-side end face of the light guide sheet, which can reduce light emission from the end face of the slit. Light can be therefore prevented from leaking from the boundary between the individual illumination areas. The mask layer which functions as the end face cover excludes formation of an additional end face cover, leading to easy production of the base sheet at low costs.

The mask layer which extends to substantially half of the end face of the slit can decrease the light emission by half. The mask layer which extends so as to cover the substantially entire end face of the slit substantially eliminates light emission.

In the illuminated key sheet of the second aspect, the base sheet may include a front sheet formed on the operation surface side of the light guide sheet so as to cover the slit, the front sheet adhering to the plurality of the illumination areas. In this configuration, since the front sheet continuously covers the illumination areas, pressing force which concentrates on the vicinity of the slit in the pressing operation can be dispersed to the front sheet, which can prevent the vicinity of the slit from being unnaturally deformed. The end face of the light guide sheet inside the slit is therefore less likely to peel from the mask layer adhering to the end face of the light guide sheet or from the end face cover, which can impart enhanced durability to the base sheet. The illuminated key sheet with high durability can be accordingly provided.

Although light may be scattered by the damaged surface of the light guide sheet and then leak, the front sheet which covers the light guide sheet can prevent the light guide sheet from being damaged, which can prevent the decrease in the efficiency of the light guiding due to the damage of the light guide sheet.

Furthermore, in the illuminated key sheet having the front sheet, the front sheet and the mask layer may be formed as the same member. Owing to this configuration, the front sheet can be provided without the increase in the number of components, leading to easy production of the base sheet at low costs.

In the illuminated key sheet having the front sheet according to the second aspect, the front sheet may be made from a flexible resin film. Since the flexible front sheet can be easily bent, the increase of pressing load can be prevented in the pressing operation even though the front sheet covers the plurality of illumination areas. In the case of pressing a contact switch having a click load, a tactile feel is therefore easily provided, leading to enhanced pressing operability. The front sheet made from the flexible resin film can be prevented from being flexibly deformed to an unnatural extent while being flexibly deformed with ease. The occurrence of the flexible deformation to an unnatural extent can be therefore prevented in the vicinity of the slit. The end face of the light guide sheet inside the slit is accordingly less likely to peel from the mask layer adhering to the end face of the light guide sheet or from the end face cover, which can impart increased durability to the base sheet.

The flexible resin film can prevent the key sheet from being damaged and cracked by repeated deformation of the key sheet in the pressing operation, which can impart increased durability to the base sheet.

Resin films which can be bonded to the front sheet by thermocompression may be used for the light guide sheet. Use of the resin films, which can be bonded to the front sheet by thermocompression, for the light guide sheet enables the front sheet to be compressively bonded to the light guide sheet with ease for integration. In addition, since the mask layer and a display layer can be preliminarily formed by printing on the front sheet, the compression-bonding of the light guide sheet to the front sheet enables the mask layer and the display layer to be simultaneously formed on the light guide sheet. Forming the mask layer by using resins which can be subjected to hot-melt bonding eliminates use of an additional adhesive layer for the compression-bonding of the front sheet to the light guide sheet, leading to easy production of the base sheet at low costs.

In the illuminated key sheet of the second aspect, a back side cover may be provided to the back side of the light guide sheet so as to cover the slit. In this configuration, the back side cover connects the illumination areas from the back side of the light guide sheet to impart an integrated structure to the illumination sheet. The back side cover covers the slit from the back side of the light guide sheet to form the integrated structure. The occurrence of the flexible deformation to an unnatural extent can be therefore prevented in the vicinity of the slit. The end face of the light guide sheet inside the slit is accordingly less likely to peel from the mask layer adhering to the end face of the light guide sheet or from the end face cover, which can impart enhanced durability to the base sheet.

The back side cover may have a penetration protrusion formed solidity as an end face cover, the penetration protrusion formed solidity filling the slit. Owing to this configuration, the penetration protrusion can cover the end face of the light guide sheet inside the slit, which can prevent light leakage from the end face of the slit. Since the penetration protrusion fills the slit formed between the adjacent illumination areas, the penetration protrusion definitely attenuate light, thereby being able to prevent light leakage from one illumination area to another illumination area.

In the illuminated key sheet of the second aspect, the base sheet may have an end face cover at least covering part of the end face of the light guide sheet, the end face forming the slit. This configuration can prevent light leakage from the end face of the slit, thereby being able to definitely prevent light leakage from one illumination area to another illumination area.

In the illuminated key sheet of the second aspect, the base sheet may include a light-shielding print layer provided to the back side of the light guide sheet to prevent light from entering the light guide sheet, the back side being opposite to the operation surface side. This configuration can prevent the light diffusely reflected inside electronic equipment from entering the light guide sheet from the back side thereof, which can prevent light which has passed through the light guide sheet in the thickness direction thereof from causing unnecessary illumination of the illumination area and from leaking.

In the case of directly forming the light-shielding print layer on the back surface of the light guide sheet, the interface between the light guide sheet and the light-shielding print layer is preferably in the form of a smooth surface. Since the smooth surface reflects light with high reflectance, the light transmitted inside the light guide sheet can be prevented from leaking from the light guide sheet. Entrance of the light to the light-shielding print layer is therefore excluded, leading to the increase in the efficiency of the light guiding.

In the illuminated key sheet having the light-shielding print layer according to the second aspect, the mask layer may have a color the same as that of the light-shielding print layer. Viewing the illuminated key sheet from the operation surface side, the boundary between the mask layer, which is formed on the operation surface side of the light guide sheet, and the light-shielding print layer, which is provided to the back side of the light guide sheet, is therefore less likely to be visually observed, which enables the mask layer and the light-shielding print layer to appear as the same layer. The mask layer formed so as to cover the slit enables the slit not to be visually observed, leading to hiding the segments of the illumination areas. The segments of the illumination areas can be accordingly prevented from appearing, thereby being able to improve designability.

In the illuminated key sheets of the first and second aspects, the light guide sheet may have a bridge which connects the areas of the light guide sheet across the slit. The bridge is preferably provided at a wide-angle position with respect to a light source to substantially eliminate light leakage to the adjacent illumination areas. This configuration can impart an integrated structure to the light guide sheet divided into the illumination areas, leading to easy handling of the light guide sheet and easy production of the base sheet. The bridge can serve to maintain the width of the slit accurate, leading to production of the base sheet having dimension stability. For example, in the case where the base sheet includes the light guide sheet made from relatively hard resins and the reinforcement made from a flexible resin film, the bridge can prevent the base sheet from being bent.

Combination of the front sheet and the bridge can enhance the durability of the light guide sheet, leading to the base sheet having enhanced durability.

In the illuminated key sheets of the first and second aspects, a transparent resin layer may be provided on the back surface of the light guide sheet, and the light guide sheet and the transparent resin layer may have smooth surfaces which contact each other. In this configuration, the contact surface between the light guide sheet and the transparent resin layer can efficiently reflect light guided inside the light guide sheet, which enables the light to be easily transmitted to a position distant from an incident position of the light in the light guide sheet. The efficiency of the light guiding of the light guide sheet can be therefore increased, thereby being able to brightly illuminate the illumination areas in the relatively uniform manner.

In the illuminated key sheet having the transparent resin layer, the light-shielding print layer may be further provided on the back surface of the transparent resin layer. This configuration can prevent light diffusely reflected inside electronic equipment from entering the back side of the light guide sheet, which can prevent light which has passed through the light guide sheet in the thickness direction thereof from causing unnecessary illumination of the illumination area and from leaking. Since the transparent resin layer is disposed between the light guide sheet and the light-shielding print layer, most of the light transmitted inside the light guide sheet is reflected at the interface between the light guide sheet and the transparent resin layer, thereby being able to suppress entrance of the light to the light-shielding print layer. Attenuation of the light to be guided can be therefore suppressed even though the light-shielding print layer is provided to the back side of the light guide sheet, leading to bright illumination of the illumination areas in the relatively uniform manner.

In the illuminated key sheet having the transparent resin layer according to the first and second aspects, the transparent resin layer may be formed by using resin having a refractive index smaller than that of the light guide sheet. This configuration enables the light transmitted inside the light guide sheet to be totally reflected with efficiency at the interface between the light guide sheet and the transparent resin layer, leading to the enhanced efficiency of the light guiding of the light guide sheet. The illumination areas can be therefore brightly illuminated.

In the illuminated key sheet having the front sheet according to the first and second aspects, the front sheet may be formed by using resin having a refractive index smaller than that of the light guide sheet. This configuration enables the light transmitted inside the light guide sheet to be totally reflected with efficiency at the interface between the light guide sheet and the front sheet, leading to the enhanced efficiency of the light guiding of the light guide sheet. The illumination areas can be therefore brightly illuminated.

Furthermore, in the cases where a diffusion layer is provided to the light guide sheet to scatter light and where the illumination areas are illuminated with light reflected by the diffusion layer, the occurrence of uneven illumination can be suppressed.

### Advantageous Effects of Invention

In the illuminated key sheet according to an aspect of the invention, since the slit divides the light guide sheet into the illumination areas, light can be prevented from leaking from one illumination area to another illumination area. Guiding light from different light sources to the respective illumination areas for illumination enables the illumination to be independently controlled in the individual illumination areas.

Since the mask layer at least covers the opening edge of the slit on the operation surface side to prevent light emitted from the end face of the slit from leaking to the operation surface side, the light can be prevented from leaking from the boundary between the individual illumination areas. Since the reinforcement covers the slit, pressing force which concentrates on the vicinity of the slit in the pressing operation can be dispersed to the reinforcement, which can prevent the vicinity of the slit from being unnaturally deformed. The end face of the light guide sheet inside the slit is therefore less likely to peel from the mask layer adhering to the end face of the light guide sheet, so that the base sheet can have increased durability. The illuminated key sheet can be provided so as to eliminate light leakage from the end face of the slit even in repeated pressing operation and so as to have high durability.

### BRIEF DESCRIPTION OF DRAWINGS

FIG. 1 is a plan view illustrating an illuminated key sheet of a first embodiment.

FIG. 2 is a cross-sectional view taken along the line SA-SA in FIG. 1.

FIG. 3 is a cross-sectional view illustrating an illuminated key sheet of a second embodiment in the manner of FIG. 2.

FIG. 4 is a cross-sectional view illustrating an illuminated key sheet of a third embodiment in the manner of FIG. 2.

FIG. 5 is a plan view illustrating an illuminated key sheet of a fourth embodiment.

FIG. 6 is a cross-sectional view taken along the line SB-SB in FIG. 5.

FIG. 7 is an enlarged cross-sectional view partially illustrating a first modification of the illuminated key sheet of the fourth embodiment.

FIG. 8 is an enlarged cross-sectional view partially illustrating a second modification of the illuminated key sheet of the fourth embodiment.

FIG. 9 is a cross-sectional view illustrating an illuminated key sheet of a fifth embodiment in the manner of FIG. 2.

FIG. 10 is a cross-sectional view illustrating an illuminated key sheet of a sixth embodiment in the manner of FIG. 2.

FIG. 11 is an enlarged cross-sectional view partially illustrating a first modification of the illuminated key sheet of the sixth embodiment.

FIG. 12 is a cross-sectional view illustrating an illuminated key sheet of a seventh embodiment in the manner of FIG. 2.

FIG. 13 is a cross-sectional view illustrating an illuminated key sheet of an eighth embodiment in the manner of FIG. 2.

FIG. 14 is a cross-sectional view illustrating an illuminated key sheet of a ninth embodiment in the manner of FIG. 2.

FIG. 15 illustrates the back surface of a first modification common to the individual embodiments.

FIG. 16 is a cross-sectional view taken along the line SC-SC in FIG. 15.

FIG. 17 is a plan view illustrating a second modification common to the individual embodiments.

FIG. 18 is a plan view illustrating a light guide sheet used for the second modification common to the individual embodiments.

### DESCRIPTION OF EMBODIMENTS

The invention will be hereinafter described further in detail with reference to the drawings. Embodiments involve examples of an illuminated key sheet used for input components of cell phones. The same configurations of the individual embodiments are denoted by the same reference signs to omit the same description. Furthermore, description of the same materials, effects, advantages, and manufacturing processes is also omitted.

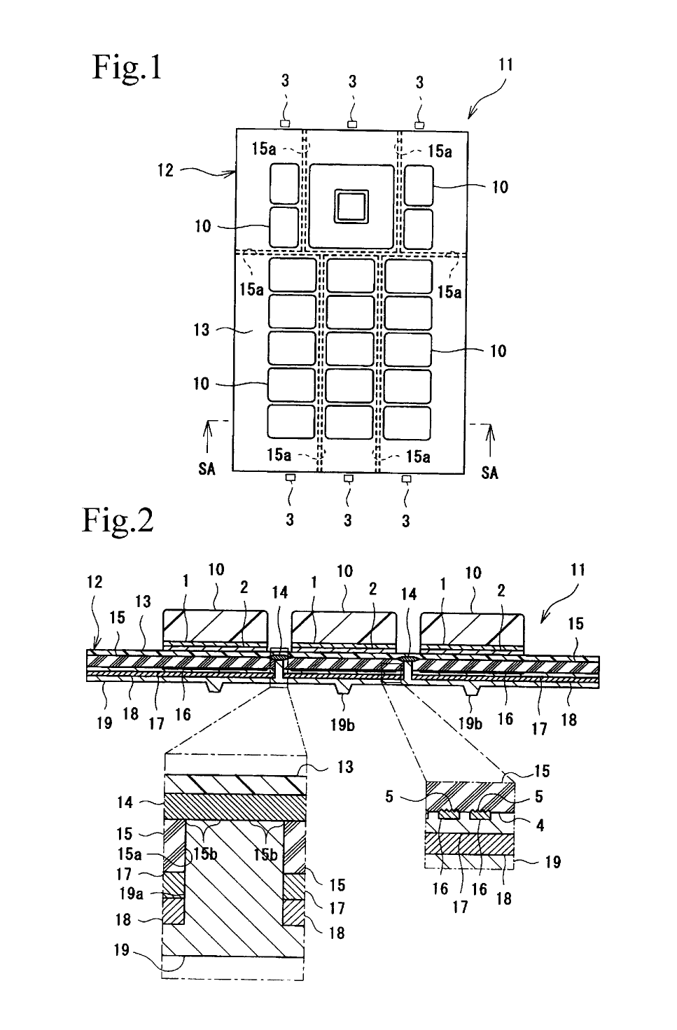

### First Embodiment (FIGS. 1 and 2)

FIGS. 1 and 2 each illustrate an illuminated key sheet 11 of a first embodiment. FIG. 1 is a plan view illustrating the illuminated key sheet 11. FIG. 2 is a cross-sectional view illustrating the illuminated key sheet 11 taken along the line SA-SA. The illuminated key sheet 11 of this embodiment includes key tops 10 and a base sheet 12. The base sheet 12 includes a front sheet 13, mask layers 14, a light guide sheet 15, diffusion layers 16, a transparent resin layer 17, a light-shielding print layer 18, and a back side cover 19.

The key tops 10 function as “depressing operation portions” in the illuminated key sheet 11 and are formed by using transparent resins in a rectangular shape in plan view. Display layers 1 are formed on the back side of the key tops 10 and serve to show display elements, the back side being opposite to the upper surface as the operation surface. The display layers 1 are attached to the base sheet 12, which will be hereinafter described, through adhesive layers 2.

For instance, the display layers 1 may have the following configuration: translucent display elements each surrounded by a light-shielding background are illuminated; or light-shielding display elements are each surrounded by a translucent background, and the peripheries of the display elements are illuminated.

The key tops 10 may be made from thermoplastic resins or reaction curable resins having high transparency. Examples of such resins include polyolefin resins, vinyl resins, acrylic resins, polyamide resins, polyester resins, polycarbonate resins, polyurethane resins, polyether resins, acetate resins, epoxy resins, silicone resins, alkyd resins, and alloy resins thereof. Among these, preferred are polycarbonate resins, acrylic resins, polyurethane resins, and acrylonitrile butadiene styrene copolymers because of easy processability and high transparency thereof. The key tops 10 with a fogged texture can visually hide the display layers 1 in the non-illumination mode and can provide a new design in which the display layers 1 can be visually recognized only in the illumination mode.

Adhesives which serve to attach the key tops 10 to the base sheet 12 can be used as the material of the adhesive layers 2. The adhesives need to have translucency to enable the display layers 1 to be illuminated with light which has passed through the base sheet 12. Examples of such adhesives include ultraviolet curable adhesives and translucent hot-melt adhesives. The adhesive layers 2 are preferably made from resins having a refractive index smaller than that of the light guide sheet 15. Owing to this configuration, light guided inside the light guide sheet 15 can be reflected to the inside of the light guide sheet 15 at the interface between the adhesive layers 2 and the light guide sheet 15, leading to the enhanced efficiency of the light guiding. Light diffusely reflected to the side of the key tops 10 by the diffusion layers 16, which will be hereinafter described, enters the interface at an obtuse angle and is not therefore substantially reflected.

In this embodiment, although the display layers 1 are provided on the back side of the key tops 10, the display layers 1 may be provided on the upper surface of the key tops 10 or on the front sheet 13 which will be hereinafter described.

The base sheet 12 has the light guide sheet 15 as the substrate and supports the key tops 10. The individual components of the base sheet 12 are hereinafter described.

The light guide sheet 15 has slits 15a and illumination areas defined by the slit 15a and transmits light in a direction intersecting the thickness direction of the light guide sheet 15 (surface direction). In this embodiment, the slits 15a define six illumination areas.

The front sheet 13 is provided on the key tops 10 provided side of the light guide sheet 15, namely, on the operation surface side. The light guide sheet 15 has an flat smooth surface 4 which contacts the front sheet 13. The term “flat” herein refers to evenness without any roughness. The term “smooth” herein refers to smoothness without any microscopic roughness which can be visually observed, for example, on a textured or mat surface. The smooth surface 4 is a mirror-finished surface or a transferred surface of a mirror-finished roll or mold. Since the light guide sheet 15 has the smooth surface 4 which contacts the front sheet 13, the contact surface between the light guide sheet 15 and the front sheet 13 can efficiently reflect the light guided inside the light guide sheet 15. Thus, the light can be easily transmitted to a position distant from an incident position of the light in the light guide sheet 15. The efficiency of the light guiding of the light guide sheet 15 can be enhanced, thereby being able to brightly illuminate the illumination areas in the relatively uniform manner.

The light guide sheet 15 has a thickness that is in the range from 30 μm to 500 μm. A thickness below 30 μm causes the quantity of the light transmitted inside the light guide sheet to decrease, resulting in the decrease of the brightness of illumination in the illuminated key sheet. At a thickness over 500 μm, the increase of deforming stress enlarges pressing load, thereby impairing operability. More preferred thickness is in the range from 100 μm to 300 μm. In this embodiment, the thickness is therefore 100 μm.

The light guide sheet 15 can be formed by using a transparent resin film, and thermoplastic resin films with high transparency are preferably employed. Examples of such materials include resin films of polyolefin resins, vinyl resins, acrylic resins, polyamide resins, polyester resins, polycarbonate resins, polyurethane resins, polyether resins, acetate resins, thermoplastic styrene elastomers, thermoplastic olefin elastomers, thermoplastic urethane elastomers, thermoplastic ester elastomers, thermoplastic vinyl chloride elastomers, thermoplastic amide elastomers, thermoplastic fluorine elastomers, and thermoplastic acrylic elastomers. Among these, preferred are resin films of polycarbonate resins, acrylic resins, polyurethane resins, thermoplastic urethane elastomers, and thermoplastic acrylic elastomers, each not having an area absorptive for wavelengths in a visible light region and having high transparency.

The light guide sheet 15 is preferably formed by using a flexible resin film, thereby imparting good press operability to the illuminated key sheet 11. The term “good press operability” herein refers to that the tactile feel of the contact switch can be clearly provided. Flexible resin films having small deforming stress may be, for instance, used for the light guide sheet 15. In particular, preferred are rubber elastic materials having rubber elasticity. Preferred examples of the rubber elastic materials include rubber elastic materials having rubber hardness A50 to A90 defined by JIS K6253. Rubber hardness larger than A90 imparts large rigidity to the illuminated key sheet with the result that the pressing load increases, resulting in the decrease in a click rate. Rubber hardness smaller than A50 may cause the light guide sheet to be largely bent with the result that the function to guide light decreases or may cause the light guide sheet to be largely deformed with the result that a defective input, such as a wrong input, occurs in the pressing operation. From these standpoints, among the above thermoplastic resin films, preferred are those of polyurethane resins and thermoplastic urethane elastomers.

The slits 15a divide the light guide sheet 15 into the six illumination areas. In this embodiment, the slits 15a separate the key tops 10 on the upper side (function keys) of the drawing from the key tops 10 on the lower side (numeric keys) thereof. The key tops 10 on the upper side (function keys) are further divided into a rectangular plate-shaped four-way key and the key tops 10 positioned at the both sides of the four-way keys. The key tops 10 on the lower side (numeric keys) are divided into three longitudinal lines. Each divided area functions as the illumination area. The slits 15a completely penetrate the light guide sheet 15. The slit 15a-side end face of the light guide sheet 15 is an even surface. In the case where the end face is the smooth surface 4, the smooth surface 4 can reflect light to the inside of the light guide sheet 15, thereby being able to suppress the leakage of the light. In this embodiment, although the slit-side end face of the light guide sheet faces the adjacent end face in parallel, the end face may be inclined toward the back side. Furthermore, in the case where the mask layer adheres to the slit-side end face of the light guide sheet, the end face may be inclined toward the substrate or the operation surface side.

The front sheet 13 forms the operation surface side of the illuminated key sheet 11. In this embodiment, the front sheet 13 functions as the “reinforcement” and adheres to the light guide sheet 15 so as to cover the entire surface thereof. The front sheet 13 connects the individual illuminated areas defined by the slits 15a to impart an integrated structure to the light guide sheet 15.

The front sheet 13 may have a thickness that is in the range from 20 μm to 200 μm. A thickness below 20 μm causes the strength of the light guide sheet 13 to decrease with the result that the front sheet 13 is easily damaged, leading to defective protection of the mask layers 14 and the light guide sheet 15. At a thickness over 200 μm, the increase of deforming stress enlarges pressing load, and the base sheet 12 has increased thickness. In this embodiment, the thickness is therefore 50 μm.

In terms of the translucency of the front sheet 13, resin films with high translucency or transparency are preferably used. The front sheet 13 preferably has a refractive index smaller than that of the light guide sheet 15. The front sheet 13 which has a refractive index smaller than that of the light guide sheet 15 can totally reflect the light transmitted inside the light guide sheet 15 in the surface direction thereof with ease. At the difference in refractive index therebetween by at least 0.06, the light can be totally reflected with efficiency. Since the light transmitted inside the light guide sheet 15 in the surface direction thereof can be totally reflected with ease in this manner, the efficiency of the light guiding increases, thereby being able to further prevent the leakage of the light. For example, in the case where the light transmitted inside the light guide sheet 15 in the surface direction thereof enters the front sheet 13, the light guide sheet 15 guides light in reduced quantity, which also reduces the quantity of light reflected by the diffusion layers with the result that the illumination areas are illuminated in a decreased degree. In addition, the light which has entered the front sheet 13 is transmitted to the display layer 1 of the illumination area which does not need the illumination while being positioned adjacent to the illumination area to be illuminated. The light may leak from this display layer 1.

Flexible resin films with translucency or transparency, softness, and elasticity can be used for the front sheet 13. Examples of such materials include resin films of polyolefin resins, vinyl resins, acrylic resins, polyamide resins, polyester resins, polycarbonate resins, polyurethane resins, polyether resins, acetate resins, thermoplastic styrene elastomers, thermoplastic olefin elastomers, thermoplastic urethane elastomers, thermoplastic ester elastomers, thermoplastic vinyl chloride elastomers, thermoplastic amide elastomers, thermoplastic fluorine elastomers, and thermoplastic acrylic elastomers. In terms of softness and easy treatment, preferred are resin films of polyamide resins, polyurethane resins, and various types of thermoplastic elastomers. Although the same material can be used for the front sheet 13 and the light guide sheet 15, use of films of hard resins, such as polycarbonate resins and acrylic resins, for the light guide sheet 15 significantly enhances an effect brought by the softness of the front sheet. In particular, since the soft front sheet 13 can be easily bent, pressing load can be prevented from increasing in the pressing operation even though the front sheet 13 covers the illumination areas, so that press operability is not decreased. The front sheet which is in the form of the flexible resin film can avoid being unnaturally bent while being easily bent. The front sheet therefore suppresses the occurrence of the unnatural bending of the slit and prevents the removal of the end faces of the light guide sheet inside the slits from the mask layers adhering to the end faces or from the end face cover, thereby being able to enhance the durability of the base sheet. In the light guide sheet 15 formed by using hard resins, since stress further concentrates on the slits relative to the light guide sheet formed by using flexible resins, the end face of the light guide sheet is likely to further easily peel from the mask layer adhering to this end face or from the end face cover. However, the front sheet 13 definitely suppresses the occurrence of the peeling to enhance the durability of the base sheet even in the case of using the hard resin film for the light guide sheet.

In the case where the front sheet 13 is formed by using flexible resin films having rubber elasticity, the repulsion of the front sheet 13 can easily prevent a gap from being formed at the interface between the front sheet 13 and the key tops 10 in the attachment of the key tops 10, which can enhance the adhesiveness of the front sheet 13 to the key tops 10. In the case of thermocompression-bonding of the key tops 10, the front sheet 13 functions as “buffering layer” which prevents the key tops 10 from deforming the light guide sheet 15. The hard key tops 10 directly bonded to the light guide sheet 15 with application of pressure may deform the light guide sheet 15 at the corners of the key tops 10. In the case of disposing the front sheet 13 having rubber elasticity between the key tops 10 and the light guide sheet 15, the front sheet 13 having the buffering effect can widely disperses the pressure while absorbing the pressure brought by the key tops 10, which enables compression bonding substantially free from the deformation of the light guide sheet 15. In particular, preferred are flexible resin films having rubber elasticity with rubber hardness A50 to A90 defined by JIS K6253. Rubber hardness up to A90 substantially excludes the increase of pressing load even in the presence of the front sheet and can therefore suppress the increase of a click rate to the minimum extent. Rubber hardness below A50 provides excessive softness and therefore decreases an effect of suppressing the occurrence of the bending, resulting in failure in preventing the end faces of the light guide sheet inside the slits from peeling from the mask layers adhering to the end faces or from the end face cover. Preferred flexible resin films having rubber elasticity are those of polyurethane resins and thermoplastic urethane elastomers.

The mask layers 14 function as a light-shielding layer which prevents light leakage from the gaps (slits) 15a between the individual light guide sheets 15 and at least covers opening edges 15b on the opening surface side of the light guide sheet 15. In this embodiment, the mask layers 14 are formed by printing or other techniques on the back side of the front sheet 13 and have a width larger than that of the slits 15a.

The mask layers 14 at least cover the opening edges 15b of the slits 15a. Preferably, the mask layers 14 entirely cover the opening and have a width more than three times the thickness of the light guide sheet 15. This configuration enables light to be sufficiently prevented from leaking from the openings of the slits 15. In the case of the light guide sheet 15 having a thickness of 100 μm, the mask layers 14 individually cover the entire openings of the slits 15a and have a width of 300 μm or larger. In the case of the light guide sheet 15 having a thin thickness, since the width of the mask layers 14 does not become so large even though it is more than three times the thickness of the light guide sheet 15, the mask layers 14 preferably have a width as large as possible in view of misalignment.

The mask layers 14 may have a thickness that is in the range from 5 μm to 50 μm. At a thickness below 5 μm, light is less likely to blocked, resulting in the failure of the light shielding. A thickness over 50 μm increases the size of steps formed by the mask layers on the operation surface side of the light guide sheet 15, resulting in the increased thickness of the base sheet 12. In the case of integrating the front sheet 13 having the mask layers 14 with the light guide sheet 15 by thermocompression-bonding, the mask layers 14 preferably have a thickness that is in the range from 10 μm to 50 μm. At a thickness below 10 μm, pressure concentrates on the edges of the light guide sheet 15 in the thermocompression-bonding. The mask layers are therefore compressed at part corresponding to the edges of the light guide sheet 15, and the thickness of this part accordingly becomes decreased, leading to light leakage from this part. In this embodiment, the thickness is therefore 5 μm.

In terms of designability, the mask layers 14 are preferably made from resins having the same color as that of the light-shielding print layer. Hence, viewed from above, the boundary between the mask layers, which are formed on the upper side of the light guide section, and the light-shielding print layer, which is provided to the lower side of the light guide section, cannot be visually recognized, thereby providing the appearance like a single sheet. In other words, the segments of the illumination areas can be hidden.

Materials which enable light shielding can be used for the mask layers 14. In the case of integrating the front sheet 13 having the preliminarily formed mask layers 14 with the light guide sheet 15, materials which enable print formation on the front sheet 13 can be used. Furthermore, for the adhesion to the light guide sheet 15, hot-melt adhesives having adhesiveness to the light guide sheet 15 can be used.

In this embodiment, although the mask layers 14 are formed on the back side of the front sheet 13, the mask layers 14 may be formed on the operation surface side of the front sheet 13. However, preferred is the configuration of this embodiment because light emitted from the end faces of the slits 15a may enter the front sheet 13 and may be then transmitted inside the front sheet 13.

The diffusion layers 16 divert the direction of light to the key tops 10, the light being guided inside the light guide sheet 15 in the surface direction thereof. The diffusion layers 16 are disposed on the back side of the light guide sheet 15 in a region with the size substantially the same as that of projection regions of the key tops 10 in the manner of dots. The diffusion layers 16 are in the form of a resin coating film containing filler with a high refractive index or high light reflectance and have a rough surface 5 which contacts the light guide sheet 15. The diffusion layers 16 may have a thickness that is in the range from 5 μm to 30 μm.

Resins which enable print formation on the light guide sheet 15 can be used as the material of the diffusion layers 16. Examples of such resins include polyolefin resins, vinyl resins, acrylic resins, polyamide resins, polyester resins, polycarbonate resins, polyurethane resins, polyether resins, acetate resins, epoxy resins, silicone resins, and alkyd resins. Among these, preferred are vinyl resins, acrylic resins, polycarbonate resins, polyester resins, polyurethane resins, epoxy resins, silicone resins, and alkyd resins, each being easily formed into ink. Examples of the filler with a high refractive index or high light reflectance include titanium oxide. Adjusting the amount of the filler enables brightness to be adjusted. For instance, the filler is added to the diffusion layers 16 near the incident position of light in a reduced amount, and the filler is added to the diffusion layers 16 distant from the incident position of the light in an increased amount, thereby imparting uniform brightness to the individual diffusion layers 16. Furthermore, the brightness may be adjusted by changing the thickness the diffusion layers 16. In the print formation of the diffusion layers 16 on the back side of the light guide sheet 15, a solvent contained in ink preferably serves to form the rough surface 5 which adheres to the light guide sheet 15. For example, in the case of the light guide sheet 15 made from polycarbonate resin films, ink containing an aromatic, ketone, or esters solvent can form the rough surface 5 which adheres to the light guide sheet 15. The rough surface 5 can easily reflect light transmitted inside the light guide sheet 15 to the key tops 10 as compared with the smooth surface 4.

The diffusion layers 16 may be formed in the shape of a display element while being disposed in the manner of dots in a region with the size substantially the same as that of projection regions of the key tops 10 in this embodiment. In this embodiment, the display layers 1 are formed on the back side of the key tops 10, and the diffusion layers 16 are formed on the back side of the light guide sheet 15. However, the display layers may be formed on the back side of the light guide sheet, and diffusion layers which reflect light to the back side may be formed on the operation surface side of the light guide sheet so as to reflect light to the back side. The diffusion layers which can control the directivity of the reflected light in this manner preferably have a prismatic rough surface. For instance, in the case of using display layers which need to be electrically controlled, the display layers are provided so as to be integrated with the circuit board, and the light guide sheet is disposed so as to overlie the display layers, thereby providing easy wiring and interconnection. In the case of using non-translucent display layers, light is emitted from the operation surface side to the display layers for illumination of a display. Examples of such a display structure include electrophoretic electronic paper.

The transparent resin layer 17 enhances the efficiency of the light guiding of the light guide sheet 15 and is formed on the back side of the light guide sheet 15 with the size substantially the same as that of the light guide sheet 15 so as to cover the diffusion layers 16. The transparent resin layer 17 is a transparent resin coating film formed as a result of applying a non-erosive coating liquid onto the light guide sheet 15 and has the flat smooth surface 4 which contacts the light guide sheet 15.

The transparent resin layer 17 may have a thickness that is in the range from 5 μm to 200 μm. At a thickness below 5 μm, even though the transparent resin film is provided so as to have the smooth surface at the interface between the light guide sheet and the transparent resin layer, formation of the light-shielding print layer causes erosion of the light guide sheet through the transparent resin layer because of the thin thickness of the transparent resin layer, which may cause defective formation of the smooth reflection surface. Since incident light from the back side and side surface of the diffusion layers through the transparent resin layer diffuses toward the display layers, formation of a transparent resin layer which certainly covers the diffusion layers can enhance brightness. Furthermore, at a thickness below 5 μm, the transparent resin layer 17 may not certainly cover the diffusion layers 16, resulting in the decrease in the quantity of the light reflected from the diffusion layers 16 to the key tops 10. At a thickness over 200 μm, the increase of deforming stress enlarges pressing load, and the base sheet 12 has increased thickness. More preferred thickness is in the range from 5 μm to 30 μm. In this embodiment, the thickness is therefore 10 μm.

The transparent resin layer 17 preferably has a refractive index smaller than that of the light guide sheet 15. The transparent resin layer 17 which has a refractive index smaller than that of the light guide sheet 15 can totally reflect the light at the interface therebetween with ease, the light being transmitted inside the light guide sheet 15 in the surface direction thereof. At the difference in refractive index therebetween by at least 0.06, the light can be totally reflected with efficiency. Since the light transmitted inside the light guide sheet 15 in the surface direction thereof can be totally reflected with ease in this manner, the efficiency of the light guiding increases, thereby being able to further prevent light leakage. Since the light-shielding print layer 18 is formed on the back side of the transparent resin layer 17, the reduction in the quantity of the light which enters the transparent resin layer 17 can lead to the reduction in the quantity of the light which enters the light-shielding print layer 18, thereby being able to suppress the absorption of the light by the light-shielding print layer 18. The reduction in the illumination brightness can be therefore suppressed even though the base sheet 12 includes the light-shielding print layer 18.

A material used for the transparent resin layer 17 is preferably a non-erosive coating liquid which has high transparency and does not erode the surface of the light guide sheet 15. Specific examples of such a material include actinic radiation curable resins, such as solventless ultraviolet-curable and EB-curable resins, curable resins, and curable resins containing non-erosive solvents such as aqueous or alcohol solvents. Examples of the resin inks which can be especially used regardless of the material of the light guide sheet 15 include ultraviolet-curable urethane acrylate inks and solventless thermosetting urethane inks. Aromatic, esters, and ketone solvents are erosive to the light guide sheet 15 made from a polycarbonate resin film while aliphatic solvents can be used as the non-erosive solvent. An ink containing the combination of an erosive solvent and a non-erosive solvent can be used as a non-erosive coating liquid in some cases. For example, in the case where an ink containing the combination of an aliphatic solvent and an aromatic solvent is prepared such that the aliphatic solvent content is at least 50%, the ink is a coating liquid non-erosive to the light guide sheet 15 made from the polycarbonate resin film. An ink containing ketone solvents can be used as a coating liquid non-erosive to the light guide sheet 15 made from a urethane resin film. The erosive or non-erosive property of these coating liquids can be determined as follows: the coating liquid is applied onto the smooth surface of the light guide sheet 15 and then wiped away in a certain time period; in the case where the initial smoothness of the surface of the light guide sheet 15 is degraded by roughness, dissolution, or swelling, the applied coating liquid is determined as the erosive coating liquid; and in the case where the initial smoothness of the surface is maintained, the applied coating liquid is determined as the non-erosive coating liquid. Since the cross-linked or curable ink is used to form the transparent resin layer 17, the transparent resin layer 17 becomes less likely to be eroded by the light-shielding print layer 18 or another print layer formed on the transparent resin layer 17.

Examples of the material having a relatively small refractive index include inks made from fluorine-modified resins such as fluorine-modified acrylic resin, silicone resins, silicone rubber, silicone-modified resins, and resins in which fine particles having a small refractive index are dispersed, the fine particles having a size sufficiently smaller than light wavelength and being able to maintain translucency thereof without the occurrence of light scattering in the case of being dispersed in the resin.

In this embodiment, although the transparent resin layer 17 is formed only on the back side of the light guide sheet 15, the transparent resin layer 17 may be provided on the operation surface side of the light guide sheet 15. In the case of forming a hereinafter described light-shielding print layer formed by application of a non-erosive coating liquid, the light-shielding print layer 18 which will be hereinafter described can be formed on the back side of the light guide sheet 15 without the transparent resin layer 17.

The light-shielding print layer 18 has dark color such as black and navy to block light and is formed on the back side of the transparent resin layer 17 so as to have the size substantially the same as that of the transparent resin layer 17. The light-shielding print layer 18 is a resin coating film formed as a result of applying a non-erosive coating liquid onto the transparent resin layer 17 and has the evenly smooth surface 4 which contacts the transparent resin layer 17. The light-shielding print layer 18 has the same color as that of the mask layers 14.

The light-shielding print layer 18 may have a thickness that is in the range from 5 μm to 50 μm. A thickness below 5 μm may cause the effect of blocking light to be decreased. A thickness over 50 μm has no influence on the effect of blocking light but causes the thickness of the base sheet 12 to be increased. In this embodiment, the thickness is therefore 5 μm.

In the case of forming the light-shielding print layer 18 on the back side of the transparent resin layer 17 by printing as in this embodiment, the light-shielding print layer 18 is preferably made from a resin having a refractive index smaller than that of the transparent resin layer 17. This approach can enhance the efficiency of light reflection at the interface between the transparent resin layer 17 and the light-shielding print layer 18.

The preferred materials used for the light-shielding print layer 18 are coating liquids non-erosive to the transparent resin layer 17, the coating liquid not dissolving and swelling the transparent resin layer 17. Such materials may be selected on the basis of the same viewpoint as described for the transparent resin layer 17. Specific examples of the materials include activation energy line-curable resins, such as solventless ultraviolet-curable and EB-curable resins, curable resins, and curable resins containing non-erosive solvents such as aqueous or alcohol solvents, for instance, ultraviolet-curable urethane acrylate inks and solventless thermosetting urethane inks. However, in use of the ultraviolet curable inks cured as a result of being exposed to ultraviolet, dye and a pigment contained in the light-shielding print layer absorb ultraviolet, resulting in insufficient curing reaction. Preferred are accordingly thermosetting urethane inks and EB-curable urethane inks. Such non-erosive coating liquids enable the smooth surface 4 to be formed at the interface between the transparent resin layer 17 and the light-shielding print layer 18. In observation of the cross-sectional surface of the base sheet 12, the smooth surface 4 brightly reflects incident light from the cross-sectional surface opposite to the observed cross-sectional surface. In contrast, in the case of using an erosive coating liquid for the light-shielding print layer 18 with the result that a rough surface is formed, totally dark diffuse reflection can be observed as if matt finish is provided.

In place of the light-shielding print layer 18, a light-shielding layer formed by another technique may be provided, such as a light-shielding coating layer formed by coating and light-shielding deposited layer formed by deposition.

The back side cover 19 covers the openings of the slits 15a, the openings being exposed at the back side opposite to the operation surface side. The back side cover 19 of this embodiment functions as the “reinforcement” and entirely covers the back sides of the six illumination areas as well as the openings of the slits 15a. The back side cover 19 has solid penetration protrusions 19a which extend in the slits 15a to fill the slits 15a. The solid penetration protrusions 19a function as the “end face cover” which covers the end faces of the light guide sheet 15, the end faces forming the slits 15a. The tips of the penetration protrusions 19a respectively adhere to the back sides of the mask layers 14. Preferred example of resins used for the back side cover 19 with the penetration protrusions 19a having translucency include semi-transparent resins having light absorbing properties and resins having a refractive index smaller than that of the light guide sheet 15 by at least 0.2, the latter resins serving to enhance the efficiency of light reflection at the interface with the slits 15a. In the case of using resins having a further smaller refractive index, the slits 15a preferably have an inclined surface which faces the substrate side or the operation surface side, thereby enhancing the efficiency of light reflection. Thus, the mask layers 14 and light-shielding print layer 18 can absorb the reflected light. Pushers 19b are formed on the back surface of the back side cover 19 so as to protrude to the back side and correspond to the key tops 10. The pushers 19b push contact switches formed on a circuit board provided to the back side of the illuminated key sheet 11. In the configuration having the penetration protrusions 19a formed in this manner, although the back side cover 19 has translucency in this embodiment, light-shielding layers formed between the end faces of the slits 15a and penetration protrusions 19a can steadily block light emitted from the end faces of the slits 15a. In the case where the back side cover 19 and the penetration protrusions 19a have light-shielding properties, the penetration protrusions 19a can block the light emitted from the end faces of the slits 15a, thereby being able to steadily block the light emitted from the end faces of the slits 15a without the light-shielding layer.

Preferred materials used for the back side cover 19 are thermoplastic, thermosetting, or light-curing flexible resins in view of demand characteristics, such as high mechanical strength, high durability, and lightness, and configuration in which the back side cover 19 entirely covers the light guide sheet 15 while filling the slits 15a. The flexible resins are preferably cured bodies of liquid resins which can easily fill the slits 15a to form the back side cover 19. The flexible resins preferably have rubber elasticity, and preferred examples of such flexible resins include rubber elastic materials having rubber hardness A30 to D70 defined by JIS K6253. Rubber hardness over D70 imparts large rigidity to the illuminated key sheet with the result that the pressing load increases, resulting in the decrease in a click rate and operability. Rubber hardness below A30 causes the pushers 19b of the back side cover 19 to be largely deformed in the pressing operation with the result that a defective input such as a wrong input occurs. Although the back side cover 19 also suppresses removal of the end faces of the light guide sheet 15 inside the slits 15b from the mask layers 14 adhering to the end faces or from the “end face cover”, the rubber hardness below A30 may cause failure in the suppression of the removal. The rubber hardness is more preferably in the range from A50 to A90. Rubber hardness less than or equal to A90 does not substantially cause the increase of the pressing load and the decrease of a click rate, leading to enhancement of operability. Rubber hardness greater than or equal to A50 can suppress the deformation of the pushers 19b, which can further enhance pressing operability.

An example of a method for manufacturing the illuminated key sheet 11 is hereinafter described.

A single resin film having a size larger than that of the light guide sheet 15 is prepared. The diffusion layers 16 are formed by printing on one surface (back side) of the resin film. The transparent resin layer 17 is then formed by printing so as to cover the diffusion layers 16. The light-shielding print layer 18 is subsequently formed by printing on the transparent resin layer 17. The slits 15a are formed as a result of drawing the resin film together with the transparent resin layer 17 and the light-shielding print layer 18 by using laser cut or a cutting die, thereby producing the resin film including the light guide sheet 15 which the diffusion layers 16, transparent resin layer 17, and light-shielding print layer 18 underlie in sequence and which has the six illumination areas. In this case, although the slits 15a define the illumination areas in the region as the light guide sheet 15, the six illumination areas are connected to each other at the outside of the periphery of the base sheet 12 in the resin film.

The front sheet 13 formed by using a flexible resin film is prepared, and the mask layers 14 are formed by printing on one surface (back side) of the front sheet 13. The front sheet 13 is set such that the back side thereof faces the resin film having the light guide sheet 15, and the front sheet 13 is bonded to the resin film for integration by thermocompression, thereby producing a multilayered sheet. The resulting multilayered sheet is inserted into a mold used for the formation of the back side cover 19, and the back side cover 19 made from silicone rubber is integrally formed on the light-shielding print layer 18, thereby producing a multilayered sheet integrated with the back side cover 19. In this process, the liquid silicone rubber enters the slits 15a to form the solid penetration protrusions 19a, and the pushers 19b are simultaneously formed by the cavity of the mold. Laser cut or a drawing die is used to draw the multilayered sheet integrated with the back side cover 19 in the size of the base sheet, thereby producing the base sheet 12.

The display layers 1 are formed by printing on the back side of the key tops 10 formed by injection molding, and the adhesive layers 2 made from a hot-melt adhesive are sequentially formed by printing.

The key tops 10 are set such that the adhesive layers 2 face the operation surface side of the base sheet 12 and are then bonded to the base sheet 12 by thermocompression, thereby completing the manufacturing of the illuminated key sheet 11.

Effects and advantages of the illuminated key sheet 11 are hereinafter described.

In the illuminated key sheet 11, the slits 15a divide the light guide sheet 15 into the six illumination areas, which can prevent light leakage from one illumination area to another illumination area. Thus, internal light sources (LEDs) 3 disposed at the periphery of the illuminated key sheet 11 introduce light to illuminate the respective illumination areas as illustrated in FIG. 1, thereby being able to independently control the illumination of the individual illumination areas.

The mask layers 14 cover the openings of the slits 15a on the operation surface side to prevent the light emitted from the end faces of the slits 15a from leaking to the operation surface side, which can prevent light leakage from the boundary between the individual illumination areas. Unlike the related art in which a light-shielding resin fills a slit to hide the end face of the slit for light-shielding, light leakage due to a repeated pressing operation which causes the end faces of the slits 15a to be exposed can be prevented, leading to high resistance to the light leakage.

The front sheet 13 forms the operation surface side of the base sheet 12. Since the front sheet 13 continuously covers the six illumination areas in this manner, pressing force which concentrates on the vicinity of the slits 15a in the pressing operation can be dispersed to the front sheet 13, which can prevent the vicinity of the slits 15a from being unnaturally deformed. Hence, the end faces of the light guide sheet 15 inside the slits 15a are less likely to peel from the penetration protrusions 19a adhering to these end faces, which can impart the enhanced durability to the base sheet 12. The illuminated key sheet 11 having increased durability can be accordingly provided.

The front sheet 13 which entirely covers the operation surface side of the light guide sheet 15 can prevent damage of the light guide sheet 15, thereby being able to prevent the decrease in the efficiency of light guiding due to the damage of the light guide sheet 15.

The flexible resin film used for the front sheet 13 can decrease the deformation stress of the front sheet 13, so that the increase of the pressing load can be prevented in the pressing operation even though the front sheet 13 entirely adheres to the six illumination areas. In the case of pressing a contact switch having a click load, a tactile feel can be therefore easily provided, leading to enhanced pressing operability. The front sheet 13 is prevented from being unnaturally deformed, which can impart enhanced durability to the front sheet 13.

Since the light guide sheet 15 is formed by using the resin film which can be bonded to the front sheet 13 by thermocompression, the front sheet 13 can be easily bonded to the light guide sheet 15 for integration. The mask layers 14 can be preliminarily formed by printing on the front sheet 13, so that the bonding of the front sheet 13 enables the mask layers 14 to be simultaneously formed on the light guide sheet 15. The mask layers 14 made from resins which enable hot-melt bonding eliminates formation of an additional adhesive layer which serves to bond the front sheet 13 to the light guide sheet 15, leading to easy production of the base sheet 12 at low costs.

Use of flexible resin films can prevent damage and breaks caused by repeated deformation due to the pressing operation, which can impart increased durability to the base sheet 12.

The light-shielding print layer 18 provided to the back side of the light guide sheet 15 can prevent light diffusely reflected inside electronic equipment from entering the back side of the light guide sheet 15, which can prevent the light which has passed through the light guide sheet 15 in the thickness direction thereof from causing unnecessary illumination of the illumination areas and from leaking.

Viewing the illuminated key sheet 11 from the operation surface side, the boundary between the mask layers 14, which are formed on the operation surface side of the light guide sheet 15, and the light-shielding print layer 18, which is provided to the back side of the light guide sheet 15, can be prevented from being visually recognized because the mask layers 14 have the same color as that of the light-shielding print layer 18. The mask layers 14 and the light-shielding print layer 18 can appear as the same layer. Thus, the mask layers 14 which cover the slits 15a can prevent the slits 15a from being visually recognized and hide the segments of the six illumination areas. The segments of the six illumination areas can be prevented from appearing, leading to enhanced designability.

Since the back side cover 19 provided to the back side of the light guide sheet 15 connects the six illumination areas, which can impart the integrated structure to the light guide sheet 15. The back side cover 19 provided to the back side of the light guide sheet 15 covers the slits 15a to form the integrated structure. The vicinity of the slits 15a are prevented from being unnaturally deformed, and the end faces of the light guide sheet 15 inside the slits 15a can be therefore prevented from peeling from the penetration protrusions 19a adhering to these end faces, which can impart the enhanced durability to the base sheet 15.

The back side cover 19 which extends over the six illumination areas to entirely cover the back side of the light guide sheet 15 can prevent the light guide sheet 15 from being damaged, thereby being able to enhance the efficiency of the light guiding of the light guide sheet 15.

Furthermore, since the light-shielding print layer 18 is disposed between the light guide sheet 15 and the back side cover 19, the light-shielding print layer 18 can be prevented from being damaged, which can prevent light from leaking at the damaged part of the light-shielding print layer 18.

Since the back side cover 19 having the solid penetration protrusions 19a is made from silicone rubber as flexible resins, the deformation of the back side cover 19 can follow the deformation of the light guide sheet 15 and the slits 15a in pressing operation, thereby being able to prevent formation of gaps between the penetration protrusions 19a and the light guide sheet 15. Light can be therefore prevented from leaking from the end faces of the slits 15a, thereby being able to definitely prevent the leakage of the light from one illumination area to another illumination area. The penetration protrusions 19a fill the slits 15a formed between the adjacent illumination areas and therefore steadily attenuate light, which can prevent the leakage of the light from one illumination area to another illumination area.

The transparent resin layer 17 is provided on the back side of the light guide sheet 15, and the light guide sheet 15 and the transparent resin layer 17 have the smooth surfaces 4 which contact each other. Thus, the contact surface between the light guide sheet 15 and the transparent resin layer 17 can efficiently reflect light guided inside the light guide sheet 15, leading to easy transmission of the light to a position distant from an incident position of the light in the light guide sheet 15. The efficiency of the light guiding of the light guide sheet 15 can be therefore enhanced, thereby being able to brightly illuminate the illumination areas in the relatively uniform manner.

The light-shielding print layer 18 provided on the back side of the transparent resin layer 17 can prevent light diffusely reflected inside electronic equipment from entering the back side of the light guide sheet 15, which can prevent light which has passed through the light guide sheet 15 in the thickness direction thereof from causing unnecessary illumination of the illumination areas and from leaking. Since the transparent resin layer 17 is disposed between the light guide sheet 15 and the light-shielding print layer 18, most of the light transmitted inside the light guide sheet 15 is reflected at the interface between the light guide sheet 15 and the transparent resin layer 17, thereby being able to suppress entrance of the light to the light-shielding print layer 18. The attenuation of the light to be guided can be therefore suppressed even though the light-shielding print layer 18 is provided to the back side of the light guide sheet 15, leading to bright illumination of the illumination areas in the relatively uniform manner.

Since the transparent resin layer 17 is formed by using a resin having a refractive index smaller than that of the light guide sheet 15, the light transmitted inside the light guide sheet 15 can be totally reflected at the interface between the light guide sheet 15 and the transparent resin layer 17 with efficiency, thereby being able to enhance the efficiency of the light guiding of the light guide sheet 15. The illumination areas can be therefore brightly illuminated.

Since the front sheet 13 is formed by using a resin having a refractive index smaller than that of the light guide sheet 15, the light transmitted inside the light guide sheet 15 can be totally reflected at the interface between the light guide sheet 15 and the front sheet 13 with efficiency, thereby being able to enhance the efficiency of the light guiding of the light guide sheet 15. The illumination areas can be therefore brightly illuminated.

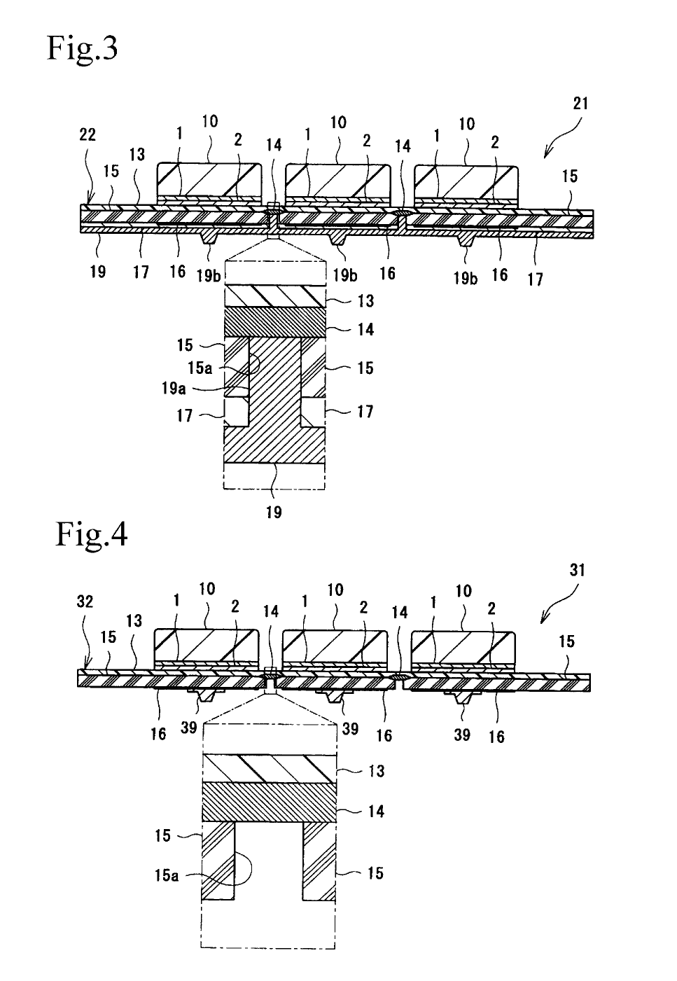

### Second Embodiment (FIG. 3)

FIG. 3 illustrates an illuminated key sheet 21 of a second embodiment. FIG. 3 is a cross-sectional view illustrating the illuminated key sheet 21. The illuminated key sheet 21 of this embodiment differs from the illuminated key sheet 11 of the first embodiment in that a base sheet 22 includes the light-shielding back side cover 19 without the light-shielding print layer. The other configurations are the same as those of the illuminated key sheet 11.

A method for manufacturing the illuminated key sheet 21 is hereinafter described. The diffusion layers 16 and the transparent resin layer 17 are formed in sequence by printing on one surface (back side) of a single resin film having a size larger than that of the light guide sheet 15. The resin film is drawn together with the transparent resin layer 17, thereby forming the slits 15a. The mask layers 14 are formed by printing on one surface (back side) of the front sheet 13 made from a flexible resin film. The front sheet 13 is set such that the back side thereof faces the resin film having the slits 15a and is then bonded thereto for integration by thermocompression. The resulting multilayered sheet is inserted into a mold used for the formation of the back side cover 19, and the back side cover 19 made from liquid silicone rubber is integrally formed on the transparent resin layer 17, thereby producing a multilayered sheet covered with the back side cover 19. The multilayered sheet is drawn in the size of the base sheet, thereby producing the base sheet 22. In this process, the penetration protrusions 19a and the pushers 19b are formed, the penetration protrusions 19a functioning as the “end face cover” to fill the slits 15a. The display layers 1 and the adhesive layers 2 made from a hot-melt adhesive are formed in sequence by printing on the back side of the key tops 10 formed by injection molding. The key tops 10 are set such that the adhesive layers 2 face the operation surface side of the base sheet 22 and are then bonded to the base sheet 22 by thermocompression, thereby completing the manufacturing of the illuminated key sheet 21.

In the illuminated key sheet 21, the back side cover 19 formed by using light-shielding silicone rubber can prevent light diffusely reflected inside electronic equipment from entering the back side of the light guide sheet 15, which can prevent the light which has passed through the light guide sheet 15 in the thickness direction thereof from causing unnecessary illumination of the illumination areas and from leaking. The penetration protrusions 19a fill the slits 15a formed between the adjacent illumination areas and therefore attenuate light, which can definitely prevent the leakage of the light from one illumination area to another illumination area. Formation of the light-shielding print layer can be therefore excluded.

### Third Embodiment (FIG. 4)

FIG. 4 illustrates the illuminated key sheet 31 of a third embodiment. FIG. 4 is a cross-sectional view illustrating the illuminated key sheet 31. The illuminated key sheet 31 of this embodiment differs from the illuminated key sheet 11 of the first embodiment in that a base sheet 32 does not include the transparent resin layer, the light-shielding print layer, and the back side cover and includes pushers 39. The other configurations are the same as those of the illuminated key sheet 11.

The pushers 39 are independent of the back side cover and do not serve to fill the slits. The pushers 39 are not deformed in the pressing operation and are therefore formed by using hard resins. The pushers 39 formed by using hard resins do not absorb impact and can accordingly clearly provide tactile feel of the contact switches.

A method for manufacturing the illuminated key sheet 31 is hereinafter described. The diffusion layers 16 are formed by printing on one surface (back side) of a single film having a size larger than that of the light guide sheet 15. The pushers 39 are then formed by using ultraviolet curable resins. The slits 15a are formed as a result of drawing the resin film, thereby producing the resin film having the six illumination areas including the diffusion layers 16 and the pushers 39. The mask layers 14 are formed by printing on one surface (back side) of the front sheet 13 formed by using a flexible resin film. The front sheet 13 is set such that the back side thereof faces the resin film having the illumination areas and is then bonded thereto for integration by thermocompression, thereby producing a multilayered sheet which the front sheet 13 overlies. The multilayered sheet is drawn in the size of the base sheet, thereby producing the base sheet 32. The display layers 1 and the adhesive layers 2 made from a hot-melt adhesive are formed in sequence by printing on the back side of the key tops 10 formed by injection molding. The key tops 10 are set such that the adhesive layers 2 face the operation surface side of the base sheet 32 and are then bonded to the base sheet 32 by thermocompression, thereby completing the manufacturing of the illuminated key sheet 31.

In the illuminated key sheet 31, the front sheet 13 can impart enhanced durability to the base sheet. The mask layers 14 prevent light leakage from the slits 15a. Formation of the transparent resin layer, light-shielding layer, and back side cover can be accordingly eliminated, which can contribute to providing the thin illuminated key sheet 31.

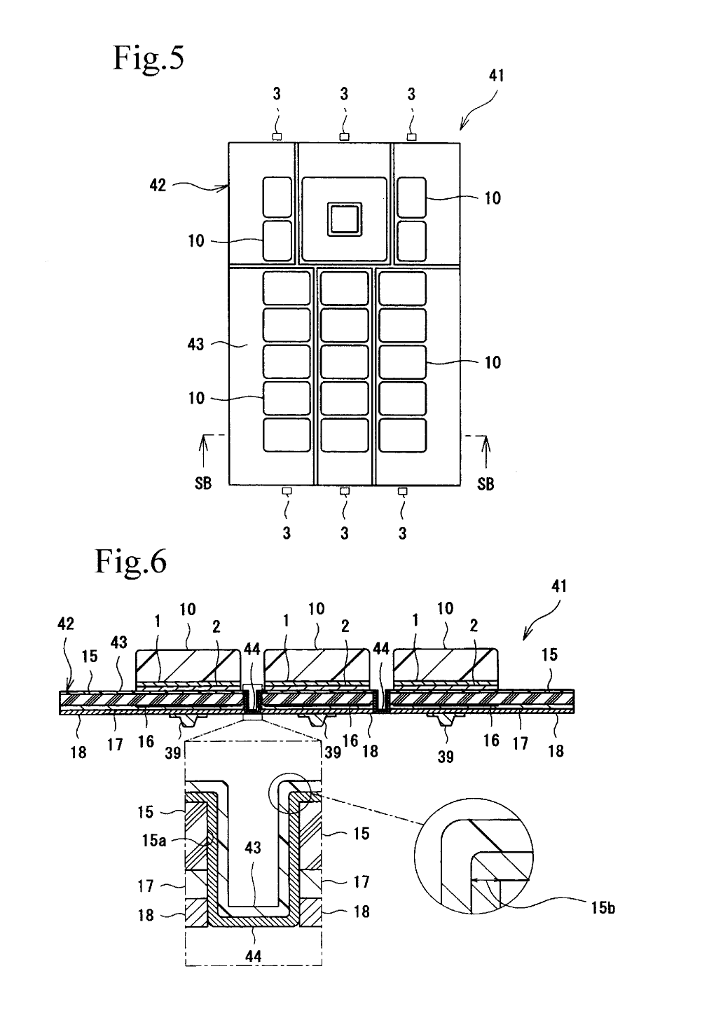

### Fourth Embodiment (FIGS. 5 and 6)

FIGS. 5 and 6 each illustrate an illuminated key sheet 41 of a fourth embodiment. FIG. 5 is a plan view illustrating the illuminated key sheet 41. FIG. 6 is a cross-sectional view illustrating the illuminated key sheet 41 taken along the line SB-SB. The illuminated key sheet 41 of this embodiment differs from the illuminated key sheet 11 of the first embodiment in a base sheet 42 including a front sheet 43 and mask layers 44 and in the pushers 39 formed without the back side cover. The other configurations are the same as those of the illuminated key sheet 11.

In this embodiment, the slits 15a have a hollow structure. As illustrated in FIG. 6, the front sheet 43 and the mask layers 44 deeply enter the inside of the slits 15a along the end faces of the light guide sheet 15, and the mask layers 44 adhere to the substantially entire end faces, the end faces forming the slits 15a. The mask layers 44 accordingly also function as an end face cover which covers the end face of the light guide sheet 15.

A method for manufacturing the illuminated key sheet 41 is hereinafter described. The diffusion layers 16, transparent resin layer 17, and light-shielding print layer 18 are formed in sequence by printing on one surface (back side) of a single resin film having a size larger than that of the light guide sheet 15. The pushers 39 are then formed by using ultraviolet curable resins. The slits 15a are formed as a result of drawing the resin film together with the transparent resin layer 17 and the light-shielding print layer 18, thereby producing the resin film having the six illumination areas with a stacked structure including the diffusion layers 16, the transparent resin layer 17, and the light-shielding print layer 18 in sequence. The mask layers 44 are formed by printing on one surface (back side) of the front sheet 43 formed by using a flexible resin film. The front sheet 43 is set such that the back side thereof faces the resin film having the illumination areas and is then bonded thereto for integration by thermocompression. In the thermocompression-bonding, a flexible embossing die is used to deform the front sheet 43 along the end faces of the slits 15a, thereby compressively bonding the front sheet 43 thereto. The multilayered sheet produced in this manner is drawn in the size of the base sheet, thereby producing the base sheet 42. The display layers 1 and the adhesive layers 2 made from a hot-melt adhesive are formed in sequence by printing on the back side of the key tops 10 formed by injection molding. The key tops 10 are set such that the adhesive layers 2 face the operation surface side of the base sheet 42 and are then bonded to the base sheet 42 by thermocompression, thereby completing the manufacturing of the illuminated key sheet 41.

In the illuminated key sheet 41, since the mask layers 44 adhere to the end faces of the slits 15a, the mask layers 44 can cover the slit 15a-side end faces of the light guide sheet 15, which can suppress emission of light from the end faces of the slits 15a. Light can be therefore prevented from leaking from the boundary between the individual illumination areas to the operation surface side. Especially in this embodiment, the mask layers 44 which adhere to the substantially entire end faces of the slits 15a can substantially eliminate emission of light from the end faces of the slits 15a, thereby being able to substantially exclude light leakage from one illumination area to another illumination area.

The front sheet 43 which continuously covers the light guide sheet 15 can prevent the vicinity of the slits from being unnaturally deformed. The end faces 15a of the light guide sheet 15 can be therefore prevented from peeling from the mask layers 44 adhering to the end faces 15a, which can impart enhanced durability to the base sheet 42.

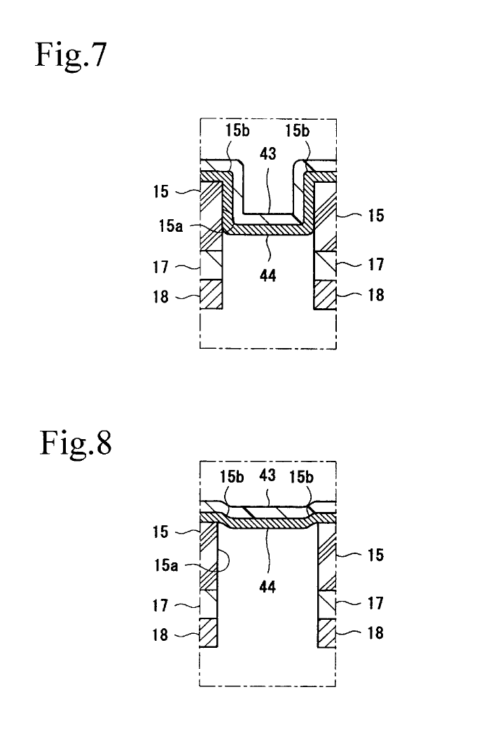

### First Modification of Fourth Embodiment (FIG. 7)

In the illuminated key sheet 41 of the fourth embodiment, the front sheet 43 deeply enters the inside of the slits 15a, and the mask layers 44 adhere to the substantially entire end faces of the slits 15a. In a first modification, the front sheet 43 and the mask layers 44 shallowly enters the inside of the slits 15a along the end faces of the slits 15a, and the mask layers 44 adhere to approximately half the end faces of the slits 15a. Hence, the mask layers 44 also function as the end face cover which covers the end faces of the light guide sheet 15.

This configuration can also prevent light leakage from the boundary between the individual illumination areas to the operation surface side. The mask layers 44 which adhere to approximately half the end faces of the slits 15a can reduce emission of light from the end faces of the slits 15a by half, thereby being able to prevent light leakage from one illumination area to another illumination area.

### Second Modification of Fourth Embodiment (FIG. 8)

In the illuminated key sheet 41 of the fourth embodiment, the front sheet 43 deeply enters the inside of the slits 15a, and the mask layers 44 adhere to the substantially entire end faces of the slits 15a. In a second modification, the front sheet 43 and the mask layer 44 does not enter the inside of the slits 15a, and the mask layers 44 do not substantially adhere to the end faces of the slits 15a.

This configuration can also prevent light leakage from the boundary between the individual illumination areas to the operation surface side.

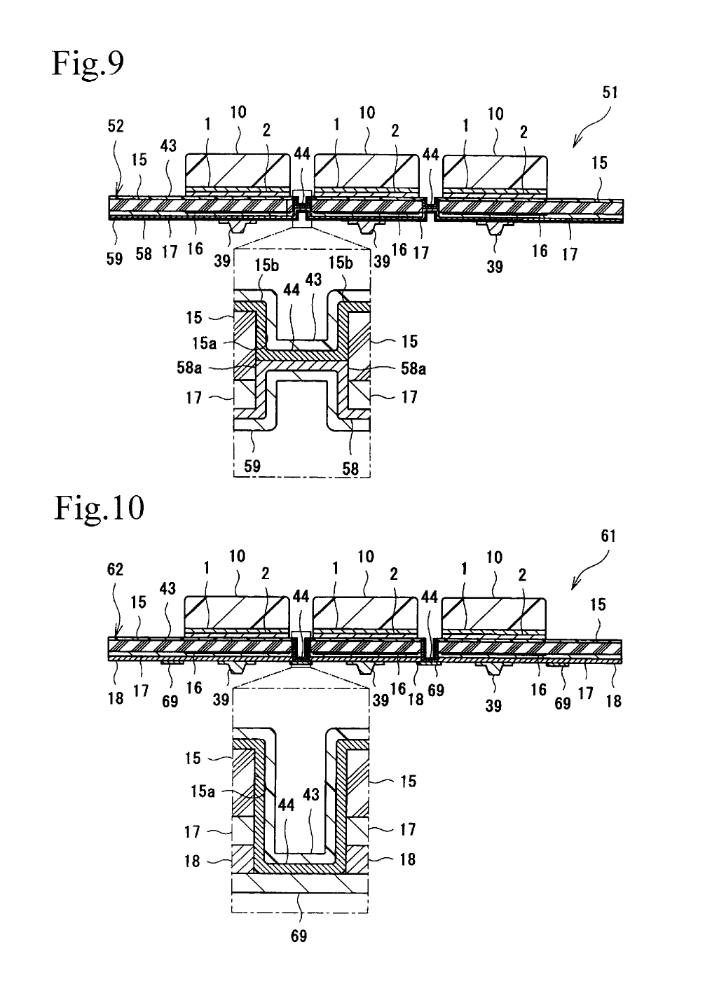

### Fifth Embodiment (FIG. 9)

FIG. 9 illustrates an illuminated key sheet 51 of a fifth embodiment. FIG. 9 is a cross-sectional view illustrating the illuminated key sheet 51. The illuminated key sheet 51 of this embodiment differs from the illuminated key sheet 41 of the fourth embodiment in that the illuminated key sheet includes a light-shielding print layer 58 and a back side cover 59. The other configurations are the same as those of the illuminated key sheet 41.

The light-shielding print layer 58 is formed on the operation surface side of the back side cover 59, which will be hereinafter described, so as to have a size substantially the same as that of the back side cover 59. The light-shielding print layer 58 shallowly enters the inside of the slits 15a together with the back side cover 59 and adheres to the mask layers 44 which also shallowly enter the inside of the slits 15a. In the light-shielding print layer 58, the part which adheres to the end faces of the slits 15a inside the slits 15a functions as the end face cover 58a.

Hot-melt adhesives are preferably used as the material of the light-shielding print layer 58.

The back side cover 59 covers the slits 15a from the back side and forms the back side of the light guide sheet 11 while functioning as the “reinforcement”. The back side cover 59 extends so as to entirely cover the back side of the six illumination areas. The back side cover 59 shallowly enters the inside of the slits 15a together with the light-shielding print layer 58. The pushers 39 are formed on the back side of the back side cover 59 and protrude so as to correspond to the key tops 10.

Flexible resin films having softness and elasticity are preferably used as the material of the back side cover 59. Examples of the material include polyamide resin films and polyurethane resin films.

A method for manufacturing the illuminated key sheet 51 is hereinafter described. The diffusion layers 16 and the transparent resin layer 17 are formed in sequence by printing on one surface (back side) of a single resin film having a size larger than that of the light guide sheet 15. The slits 15a are formed as a result of drawing the resin film together with the transparent resin layer 17, thereby producing the resin film having the six illumination areas with a stacked structure including the diffusion layers 16 and the transparent resin layer 17. The mask layers 44 are formed by printing on one surface (back side) of the front sheet 43 formed by using a flexible resin film. The light-shielding print layer 58 is formed by printing on one surface (operation surface side) of the back side cover 59 formed by using a flexible resin film. The front sheet 43 is set such that the back side thereof faces the surface of the resin film having the illumination areas while the back side cover 59 is set such that the light-shielding print layer 58 faces the transparent resin layer 17 of the resin film having the illumination areas, and individual members are bonded to each other for integration by thermocompression. In other words, the light guide sheet 15 is interposed between the front sheet 43 and the back side cover 59 for integration. In the thermocompression-bonding, a flexible embossing die is used to make the front sheet 43 and the back side cover 59 enter the inside of the slits 15a, thereby attaching the mask layers 44 to the light-shielding print layer 58. The pushers 39 are then formed on the back side of the back side cover 59 by using ultraviolet curable resins. The multilayered sheet produced in this manner is drawn in the size of the base sheet, thereby producing the base sheet 52. The display layers 1 and the adhesive layers 2 made from a hot-melt adhesive are formed in sequence by printing on the back side of the key tops 10 formed by injection molding. The key tops 10 are set such that the adhesive layers 2 face the operation surface side of the base sheet 52 and are then bonded to the base sheet 52 by thermocompression, thereby completing the manufacturing of the illuminated key sheet 51.

In the illuminated key sheet 51, the front sheet 43 is formed on the surface of the light guide sheet 15 so as to cover the slits 15a, and the back side cover 59 is provided to the back side of the light guide sheet 15 so as to cover the slits 15a. Thus, the illumination areas are combined from the two sides of the light guide sheet 15, thereby imparting the integrated structure to the illuminated sheet 15. The front sheet 43 and the back side cover 59 disperse pressing force applied to the slits 15a in the pressing operation, which can prevent the vicinity of the slits 15a from being unnaturally deformed. The end faces of the light guide sheet inside the slits 15a can be therefore prevented from peeling from the mask layers adhering to these end faces or from the end face cover, which can impart enhanced durability to the base sheet. The illuminated key sheet 51 having high durability can be accordingly provided.

The two sides of the light guide sheet 15 are covered, which can definitely suppress the decrease in the efficiency of the light guiding due to damage of the light guide sheet 15.

Since the back side cover 59 is formed by using a resin film, the back side cover 59 can be prevented from being damaged, thereby being able to provide the back side cover 59 with high durability.

Furthermore, the light-shielding print layer 58 is disposed between the light guide sheet 15 and the back side cover 59, the light-shielding print layer 58 can be prevented from being damaged, which can prevent light leakage from the damaged portion of the light-shielding print layer 58. Since the light-shielding print layer 58 formed from the hot-melt adhesive by printing can be bonded to the light guide sheet 15 by thermocompression, formation of an additional adhesive layer is eliminated, leading to easy production of the base sheet 52 at low costs.

The front sheet 43 and the back side cover 59 enter the inside of the slits in the same depth and adhere to the slits through the mask layers 44 and the light-shielding print layer 58, respectively. The mask layers 44 and the end face cover 58a of the light-shielding print layer 58 can therefore cover the substantially entire end faces of the light guide sheet 15 inside the slits 15a, thereby being able to prevent light leakage from the inside of the slits 15a. Light can be accordingly prevented from leaking from one illumination area to another illumination area. Since the light guide sheet 15 is disposed between the front sheet 43 and the back side cover 59 each adhering inside the slits 15a, the front sheet 43 and the back side cover 59 can be prevented from peeling from the light guide sheet 15, which can impart enhanced durability to the base sheet 52.

The front sheet 43 and the back side cover 59 are formed by using a resin film and can therefore have the same strength. The front sheet 42 and the back side cover 59 formed by using the same resin film can be uniformly integrated with the light guide sheet 15 from the two surfaces thereof. Thus, even in the case of using a resin film having a linear expansion coefficient largely different from that of the light guide sheet 15, the base sheet 52 is not bent resulting from temperature change, leading to production of the illuminated key sheet used for wide application.

### Sixth Embodiment (FIG. 10)

FIG. 10 illustrates an illuminated key sheet 61 of a sixth embodiment. FIG. 10 is a cross-sectional view illustrating the illuminated key sheet 61. The illuminated key sheet 61 of this embodiment differs from the illuminated key sheet 41 of the fourth embodiment in that a reinforcing frame 69 as the “back side cover” is provided on the back side of the base sheet 42 to form a base sheet 62. The other configurations are the same as those of the illuminated key sheet 41.

The reinforcing frame 69 covers the slits 15a from the back side and is formed in a grid shape along the periphery of the group of the key tops 10 and along the slits 15a. The reinforcing frame 69 has rigidity which can suppress a warp of the base sheet 42.

Materials having high rigidity are used for the reinforcing frame 69. Examples of such materials include hard resins and thin metallic plates. Examples of the hard resins include polycarbonate resins, polymethylmethacrylate resins, polypropylene resins, polystyrene resins, polyarylene sulfide copolymer resins, polyolefin resins, acrylonitrile butadiene styrene resins, polyester resins, epoxy resins, polyurethane resins, polyimide resins, polyamide resins such as polyamidimide resin, silicone resins, amino resins such as melamine resin, allyl resins, furan resins, phenol resins, fluorine resins, polyarylate resins, polyallyl sulfone resins, polyether sulfone resins, polyphenylene ether resins, polyphenylene sulfide resins, and polysulfone resins. Examples of the thin metallic plates include stainless steel, copper, and brass.

The reinforcing frame 69 may not entirely cover the slits 15a, which define the illumination areas, from the back side and may also partially cover the slits 15a within the effects of enhancing the durability of the base sheet 42 and preventing a warp. The reinforcing frame 69 may be formed at a position other than the slits 15a as in the case of being formed along the periphery of the group of the key tops 10.

A method for manufacturing the illuminated key sheet 61 is hereinafter described. A multilayered sheet having the configuration the same as that of the base sheet 42 is produced in the manner the same as that in the production of the illuminated key sheet 41. The reinforcing frame 69 drawn in the grid shape is prepared and is compressively bonded onto the back side of the multilayered sheet having the configuration the same as that of the base sheet 42 for integration. The resultant product is drawn in the size of the base sheet, thereby producing the base sheet 62. The display layers 1 and the adhesive layers 2 made from a hot-melt adhesive are formed in sequence by printing on the back side of the key tops 10 formed by injection molding. The key tops 10 are set such that the adhesive layers 2 face the operation surface side of the base sheet 62 and are then bonded to the base sheet 62 by thermocompression, thereby completing the manufacturing of the illuminated key sheet 61.

In the illuminated key sheet 61, the reinforcing frame 69 is provided to the back side of the light guide sheet 15 so as to cover the slits 15a. Since the reinforcing frame 69 connects the illumination areas from the back side of the light guide sheet 15, the light guide sheet 15 can therefore have the integrated structure, leading to easy production of the base sheet 62 at low costs. Pressing force can be applied not to one illumination area of the light guide sheet 15 but to the illumination areas of the light guide sheet 15 in the pressing operation, which can prevent one illumination area of the light guide sheet 15 from being unnaturally deformed.

Since the reinforcing frame 69 functions as the “back side cover”, the reinforcing frame 69 can maintain the shape of the slits 15a, thereby being able to provide the illuminated key sheet 61 which is less likely to be bent. For instance, even in the case of providing the illuminated key sheet 61 to a housing having an operation opening without a partition frame, the shape of the slits 15a can be maintained, leading to accurate pressing operation.

Since the shape of the slits 15a can be maintained, the mask layers 44 adhering to the end faces of the slits 15a can be prevented from peeling from the end faces of the slits 15a, which can impart enhanced durability to the base sheet 62. Light can be prevented from leaking from the end faces of the slits 15a, thereby being able to definitely suppress the leakage of the light from one illumination area to another illumination area.

The reinforcing frame 69 is provided so as to correspond to the slits 15a which define the illumination areas and therefore does not correspond to the projection positions of the key tops 10. The increase of pressing load can be accordingly suppressed, thereby being able to maintain good pressing operability.

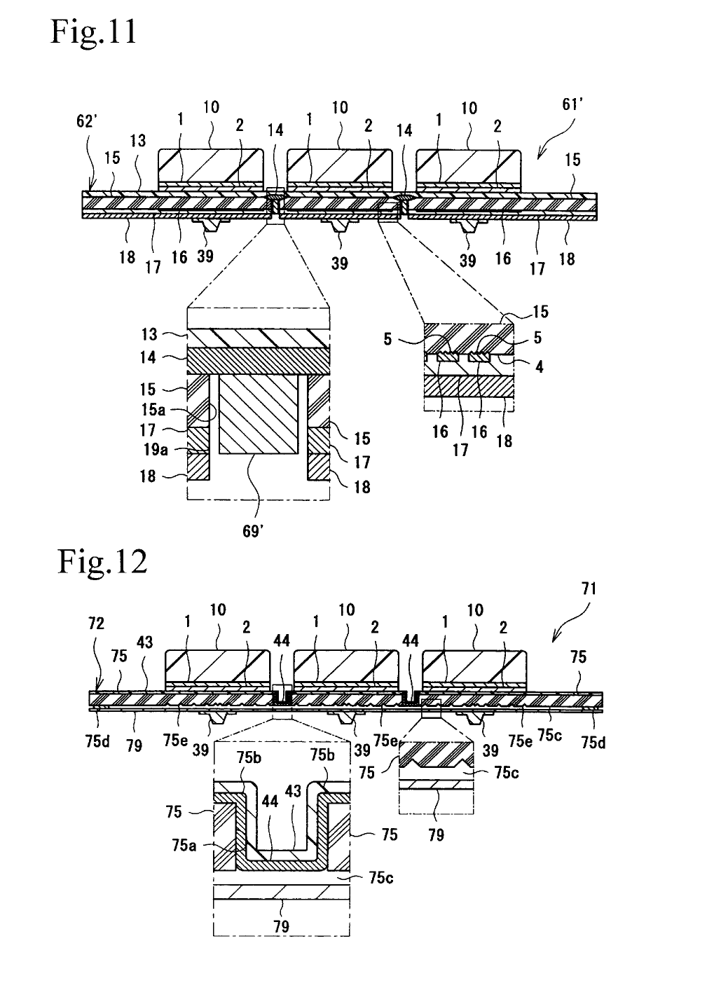

### First Modification of Sixth Embodiment (FIG. 11)

FIG. 11 illustrates an illuminated key sheet 61′ as a first modification of the sixth embodiment. The reinforcing frame may be disposed inside the slits. For example, the illuminated key sheet 61′ includes a reinforcing frame 69′ provided inside the slits 15a.

The illuminated key sheet 61′ can be manufactured as follows.

The diffusion layers 16, the transparent resin layer 17, and the light-shielding print layer 18 are formed in sequence by printing on a resin film having the size larger than that of the light guide sheet 15. The pushers 39 are formed by using ultraviolet curable resin. The slits 15a are then formed by using laser cut or a drawing die, thereby producing the resin film having the six illuminated areas. The mask layers 14 are formed by printing on the front sheet 13 made from a flexible resin film. The reinforcing frame 69′ drawn in the grid shape is prepared. The front sheet 13 is set so as to face the resin film and the reinforcing frame 69′ and is then bonded thereto by thermocompression for integration, thereby producing a multilayered sheet. The resultant product is drawn in the size of the base sheet, thereby producing the base sheet 62′. The key tops 10 are attached to the base sheet 62′ as in the other embodiments, thereby completing the manufacturing of the illuminated key sheet 61′.

Since the illuminated key sheet 61′ includes the reinforcing frame 69′, the reinforcing frame 69′ can serve to maintain the shape of the slits 15a, thereby being able to provide the illuminated key sheet 61′ which is less likely to be bent. For instance, even in the case of providing the illuminated key sheet 61′ to a housing having an operation opening without a partition frame, the shape of the slits 15a can be maintained, leading to accurate pressing operation.

In the case of using light-shielding materials for the reinforcing frame 69′, light can be prevented from leaking from the end faces of the slits 15a, thereby being able to definitely suppress the occurrence of light leakage from one illumination area to another illumination area.

In the case of using materials having high reflectance, such as metal, for the reinforcing frame 69′, the reinforcing frame 69 can reflect light which has leaked from one illumination area through the slits 15a and then return the light to this one illumination area. The decrease in brightness due to light leakage from the slits 15a can be therefore suppressed, leading to the enhanced brightness of the illumination.

The reinforcing frame 69′ is disposed within the thickness of the light guide sheet 15, which can eliminate the increase in the thickness of the illuminated key sheet 61′. A thin illuminated key sheet 61′ can be provided while having the reinforcing frame 69′.

### Seventh Embodiment (FIG. 12)

FIG. 12 illustrates an illuminated key sheet 71 of a seventh embodiment. FIG. 12 is a cross-sectional view illustrating the illuminated key sheet 71. The illuminated key sheet 71 of this embodiment differs from the illuminated key sheet 41 of the fourth embodiment in a base sheet 72 including a light guide sheet 75 and a resin sheet 79 without the diffusion layers, transparent resin layer, and light-shielding print layer. The other configurations are the same as those of the illuminated key sheet 41.

The light guide sheet 75 forms the illumination areas of the illuminated key sheet 71 and transmits light in the thickness direction thereof as in the light guide sheet 15. Slits 75a divide the light guide sheet 75 into the six segments. The light guide sheet 75 differs from the light guide sheet 15 in its back surface formed as a diffusion surface 75e which diverts the light path to the key tops 10. The diffusion surface 75e has the size substantially the same as that of the projection regions of the key tops 10 and has a rough surface profile.

A transparent resin layer may be provided on the diffusion surface in a modification. In this case, the difference of a refractive index between the light guide sheet 75 and the transparent resin layer is preferably 0.1 or higher. At a refractive index smaller than 0.1, the critical angle for reflection decreases, and the efficiency of light reflection by the rough surface therefore decreases, resulting in the fear of insufficient illumination.

The resin sheet 79 has dark color such as black and navy to block light and has a size substantially the same as that of the six light guide sheets 75. The pushers 39 are formed on the back side of the resin sheet 79. The operation surface side of the resin sheet 79 does not adhere to the back side of the light guide sheet 75 to form space 75c and adheres to adhesive layers 75d provided at positions corresponding to the periphery of the group of the key tops 10.

A method for manufacturing the illuminated key sheet 71 is hereinafter described. One surface (back side) of a single resin film having a size larger than that of the light guide sheet 75 is pressed against a mold to form the diffusion surface. The slits 75a are formed as a result of punching the resultant product, thereby producing the resin film having the six illumination areas. The mask layers 44 are formed by printing on one surface (back side) of the front sheet 43 made from a flexible resin film. The front sheet 43 is set such that the back side thereof faces the resin film having the illumination areas and is then bonded thereto by thermocompression for integration. The resultant product is punched in the size of the base sheet, thereby producing the light guide sheet 75 integrated with the front sheet 43 and the mask layers 44. In the thermocompression-bonding, a soft embossing die is used to deform the front sheet 43 along the end faces of the slits 75a, thereby compressively bonding the front sheet 43 thereto. The transparent resin sheet 79 is prepared, and the pushers 39 are formed on one side (back side) thereof by using ultraviolet curable resin. The resin sheet 79 is attached to the back side of the light guide sheet 75 through the adhesive layers 75d formed on the operation surface side of the resin sheet 79, thereby producing the base sheet 72. The display layers 1 and the adhesive layers 2 made from a hot-melt adhesive are formed in sequence by printing on the back side of the key tops 10 formed by injection molding. The key tops 10 are set such that the adhesive layers 2 face the operation surface side of the base sheet 72 and are then bonded to the base sheet 72 by thermocompression, thereby completing the manufacturing of the illuminated key sheet 71.

In the illuminated key sheet 71, since the light guide sheet 75 has the diffusion surface 75e which diffuses light, the illumination areas can be illuminated with light reflected by the diffusion surface 75e, thereby being able to suppress the occurrence of uneven illumination.

Since the space 75c is formed to the back side of the light guide sheet 75, light guided inside the light guide sheet 75 can be efficiently reflected by the back surface of the light guide sheet 75. The light can be therefore easily transmitted to a position distant from the incident position of light in the light guide sheet 75. The efficiency of the light guiding of the light guide sheet 75 can be accordingly enhanced, leading to relatively uniform illumination of the illumination areas with brightness.

The resin sheet 79 provided to the back side of the light guide sheet 75 can prevent light diffusely reflected inside electronic equipment from entering the back side of the light guide sheet 75, which can prevent the light which has passed through the light guide sheet 75 in the thickness direction thereof from causing unnecessary illumination of the illumination areas and from leaking.

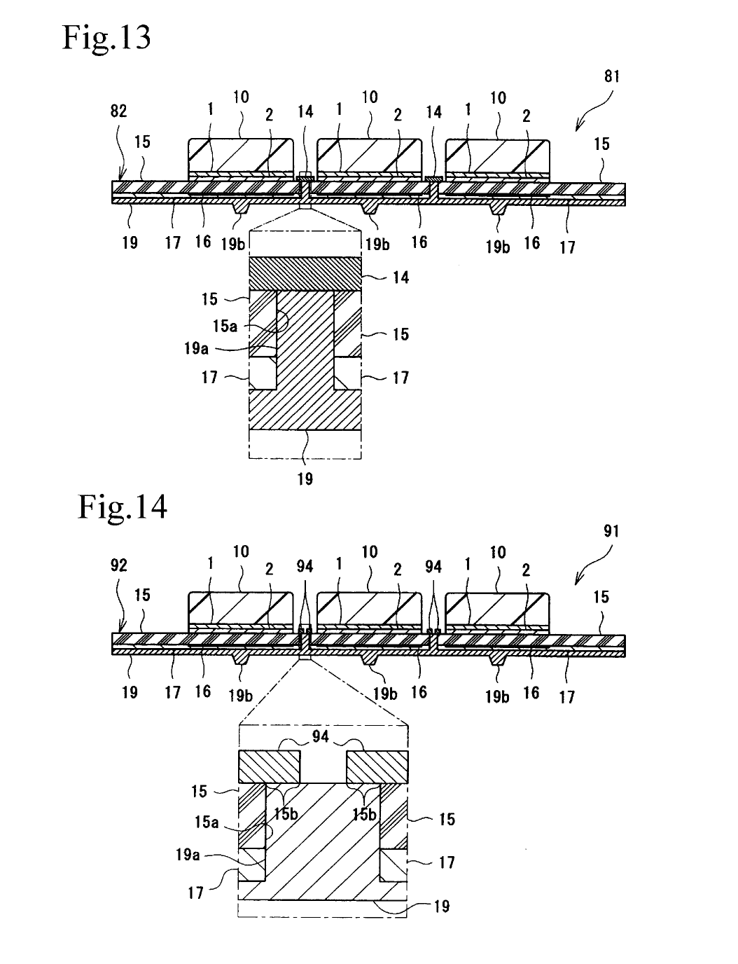

### Eighth Embodiment (FIG. 13)

FIG. 13 illustrates an illuminated key sheet 81 of an eighth embodiment. FIG. 13 is a cross-sectional view illustrating the illuminated key sheet 81. The illuminated key sheet 81 of this embodiment differs from the illuminated key sheet 21 of the second embodiment in that the base sheet 82 does not include the front sheet. The other configurations are the same as those of the illuminated key sheet 21.

A method for manufacturing the illuminated key sheet 81 is hereinafter described. A single resin film having one surface (surface side) covered with a separating film and having a size larger than that of the light guide sheet 15 is prepared. The diffusion layers 16 and the transparent resin layer 17 are formed in sequence by printing on the other surface (back side) of the resin film. The resin film is drawn together with the transparent resin layer 17 while the separating film is not cut, and part of the resin film which corresponds to the slits 15a is removed from the separating film, thereby producing the multilayered film having the six illumination areas with a stacked structure including the diffusion layers 16 and the transparent resin layer 17. This multilayered film is inserted into a mold used for the formation of the back side cover 19, and the back side cover 19 made from liquid silicone rubber is integrally formed on the transparent resin layer 17. In this process, the penetration protrusions 19a and the pushers 19b are formed, the penetration protrusions 19a filling the slits 15a. The separating film is removed from the multilayered film having the back side cover 19, and the mask layers 14 are formed on the operation surface side (surface side) of the multilayered film so as to cover the slits 15a. The resultant product is drawn in the size of the base sheet, thereby producing the base sheet 82. The display layers 1 and the adhesive layers 2 made from a hot-melt adhesive are formed in sequence by printing on the back side of the key tops 10 formed by injection molding. The key tops 10 are set such that the adhesive layers 2 face the operation surface side of the base sheet 82 and are then bonded to the base sheet 82 by thermocompression, thereby completing the manufacturing of the illuminated key sheet 81.

In the illuminated key sheet 81, since the back side cover 19 imparts an integrated structure to the light guide sheet 15, use of the front sheet is excluded, leading to easy production of the base sheet 82 at low costs. In the case of using a flexible resin film for the mask layers 14, the mask layers 14 can complement the integrated structure imparted to the light guide sheet 15, which can enhance the durability of the base sheet 82.

### Ninth Embodiment (FIG. 14)

FIG. 14 illustrates an illuminated key sheet 91 of a ninth embodiment. FIG. 14 is a cross-sectional view illustrating the illuminated key sheet 91. The illuminated key sheet 91 of this embodiment differs from the illuminated key sheet 81 of the eighth embodiment in a base sheet 92 including mask layers 94. The other configurations are the same as those of the illuminated key sheet 81.

The mask layers 94 of this embodiment do not entirely cover the openings of the slits 15a formed in the light guide sheet 15 and cover the opening edges 15b of the slits 15a. The penetration protrusions 19a of the back side cover 19 can be visually recognized between the mask layers 94.

A method for manufacturing the illuminated key sheet 91 is hereinafter described. As in the illuminated key sheet 81, the light guide sheet 15, the diffusion layers 16, the transparent resin layer 17, and the back side cover 19 are integrated with each other, thereby producing the multilayered film. The mask layers 94 are formed on the operation surface side of the multilayered film, and the resultant product is drawn in the size of the base sheet, thereby producing the base sheet 92. The display layers 1 and the adhesive layers 2 made from a hot-melt adhesive are formed in sequence by printing on the back side of the key tops 10 formed by injection molding. The key tops 10 are set such that the adhesive layers 2 face the operation surface side of the base sheet 92 and are then bonded to the base sheet 92 by thermocompression, thereby completing the manufacturing of the illuminated key sheet 91.

In the illuminated key sheet 91, use of the front sheet can be excluded as in the illuminated key sheet 81, leading to easy production of the base sheet 92 at low costs. In the case of using a flexible resin film for the mask layers 94, the mask layers 94 can complement the integrated structure imparted to the light guide sheet 15, which can enhance the durability of the base sheet 92.

Modifications common to the individual embodiments will be hereinafter described. Although modifications of the illuminated key sheet 31 of the third embodiment will be described as representative examples, the other illuminated key sheets 11, 21, 41, 51, 61, 71, 81, and 91 can be similarly modified.

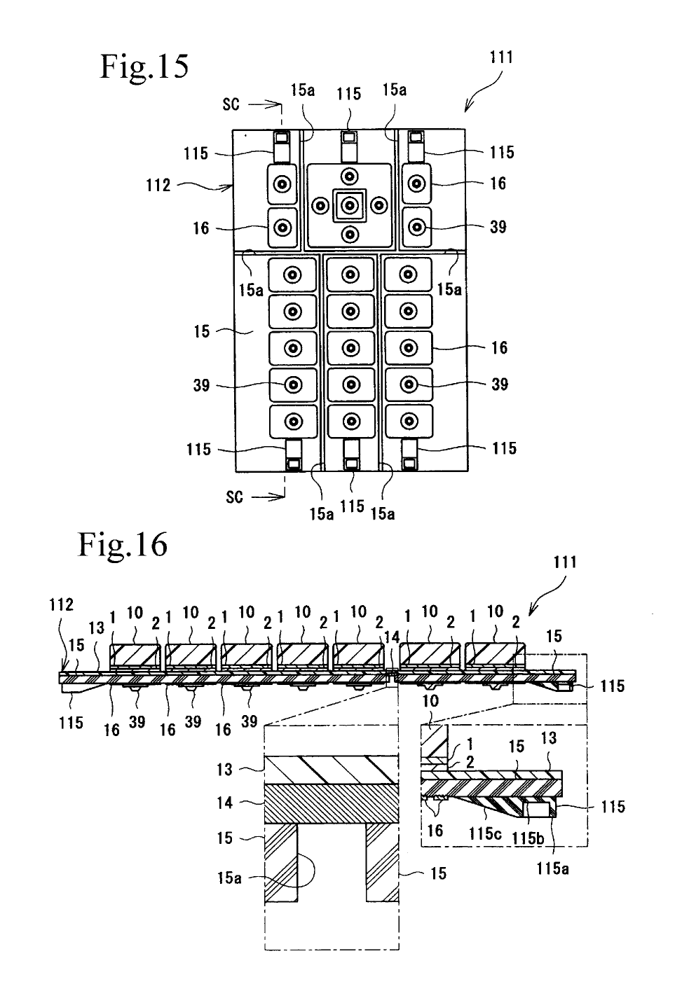

### First Modification Common to Embodiments (FIGS. 15 and 16)

In the illuminated key sheet 31, LEDs positioned at the periphery of the base sheet 32 emit light to the side surface of the light guide sheet 15. In contrast, in an illuminated key sheet 111 of a first modification, a light receiver 115 is provided on the back side of each of the six light guide sheets 15 of a base sheet 112.

The light receiver 115 efficiently guides the light emitted by the LED to the light guide sheet 15 and defines the dimension of the gap between a circuit board including the LED and the base sheet 112. The light receiver 115 has a planar block shape in plan view and is formed by using translucent resins. The light receiver 115 has a contact surface 115a which faces and contacts the circuit board. An accommodation cavity 115b is formed in the contact surface 115a to accommodate the LED. The light receiver 115 has a side surface as an inclined surface 115c in the direction of the light guiding, the inclined surface 115c having a thickness gradually decreasing toward the light guide sheet 15.

The contact surface 115a of the light receiver 115 contacts the circuit board, thereby being able to define the gap between the circuit board and the light guide sheet 15 as the thickness of the light receiver 115. The dimension of the gap between the circuit board and the base sheet 112 can be accordingly determined. The accommodation cavity 115b of the light receiver 115 has a size at least larger than that of the LED in plan view. The LED is preferably spaced apart from the side surface of the accommodation cavity 115b with a gap of approximately 0.2 mm. At the gap of approximately 0.2 mm, the LED can easily engage with the accommodation cavity 115b, thereby prevent the misalignment of the circuit board with the illumination key sheet 111. The accommodation cavity 115b preferably has a depth at least enough to cover the light-emitting surface of the LED. The inclined surface 115c of the light receiver 115 reflects the light emitted by the LED to the light guide sheet 15, thereby enabling the light to be sufficiently guided to the light guide sheet 15. The angle between the inclined surface 115c and the back side of the light guide sheet 15 is preferably in the range from 2° to 10°. At an angle below 2°, a gentle inclination enlarges the size of the inclination surface, leading to the increase in the size of the light receiver. At an angle over 10°, an incident angle of light reflected by the inclined surface to the light guide sheet decreases. The light guiding by the total reflection inside the light guide sheet therefore becomes difficult with the result that the light easily leaks to the outside. The efficiency of the light guiding accordingly decreases, leading to the decrease in the illumination brightness at a position distant from the LED. In order to enhance the efficiency of the light guiding, the angle is preferably in the range from 2° to 5°.

Highly transparent resins can be used as the material of the light receiver 115 and include flexible resins and rubber elastic materials. In terms of defining the distance between the circuit board and the base sheet 112, the material preferably has rubber hardness of at least A50 or higher to eliminate the occurrence of excessive deformation in attachment of the illuminated key sheet 111 to the circuit board with application of pressure. Especially in the case where high precision is demanded, the material preferably has rubber hardness of D70 or higher. Examples of the rubber elastic materials include acrylic rubber, silicone rubber, urethane rubber, ethylene propylene rubber, and butadiene rubber. Examples of the resins include polyolefin resins, vinyl resins, acrylic resins, polyamide resins, polyester resins, polycarbonate resins, polyurethane resins, polyether resins, acetate resins, epoxy resins, silicone resins, thermoplastic styrene elastomers, thermoplastic olefin elastomers, thermoplastic urethane elastomers, thermoplastic ester elastomers, thermoplastic vinyl chloride elastomers, thermoplastic amide elastomers, thermoplastic fluorine elastomers, and thermoplastic acrylic elastomers. Among these, preferred are acrylic resins, epoxy resins, polyurethane resins, and polyester resins, each having high fixing strength with respect to the light guide sheet 15.

The light receiver 115 preferably has a refractive index smaller than that of the light guide sheet 15. This refractive index makes the angle of refraction in the light guide sheet 15 close to the right angle. The direction of light which has entered the inside of the light guide sheet 15 can accordingly become close to the surface direction of the sheet, which can prevent light leakage and therefore enhance the efficiency of the light guiding.

The light receiver 115 can even guide the light emitted by the LED to the light guide sheet surrounded by another light guide sheet, which enables formation of illumination areas which do not face the periphery of the base sheet.

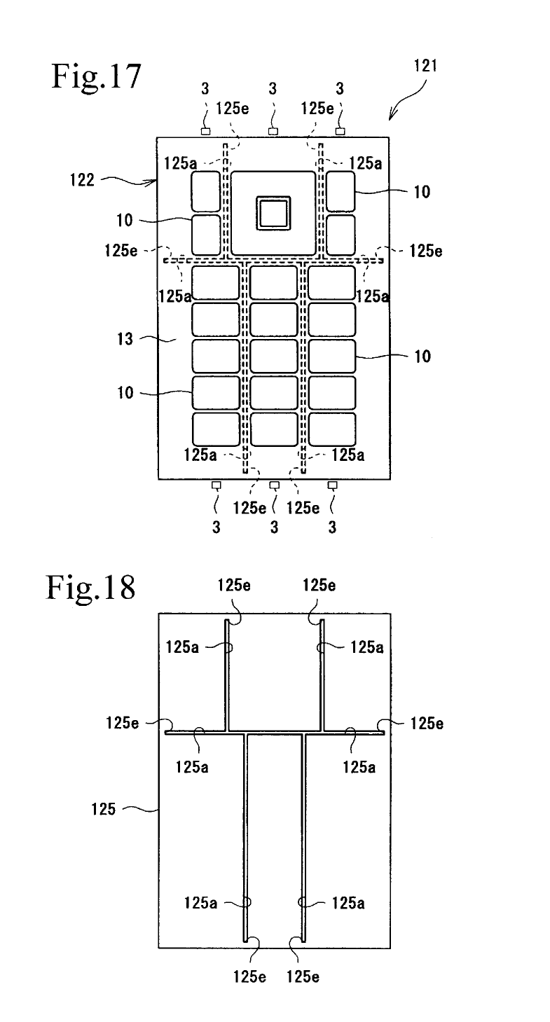

### Second Modification Common to Embodiments (FIGS. 17 and 18)

In the illuminated key sheet 31, the six light guide sheets 15 of the base sheet 32 are completely separated by the slits 15a. In contrast, in an illuminated key sheet 121 of a second modification, a base sheet 122 includes a light guide sheet 125 having six sections, and the light guide sheet 125 has bridges 125e which connects the adjacent sections of the light guide sheet 125 across slits 125a.

This configuration can impart an integrated structure to the light guide sheet 125 having the six illuminated areas and enables the light guide sheet 125 to be easily treated, leading to easy production of the base sheet 122. Furthermore, the bridge 125e can accurately maintain the size of the slits 125a, which enables production of the base sheet 122 having dimension stability.

### Third Modification Common to Embodiments

Although the illuminated key sheet 31 has the display layers 1 provided on the back side of the key tops 10, a third modification eliminates formation of the display layers 1 and includes the diffusion layers formed on the light guide sheet so as to function as display elements.

Imparting the configuration of the third modification to embodiments having the high efficiency of the light guiding and the modifications thereof provides new design having brightly luminous display elements.

### Fourth Modification Common to Embodiment

Although the key tops formed by injection molding are used in the embodiments, hard resins may be used to directly form the key tops on the base sheet. Translucent resins can be used for the key tops, and highly transparent resins are preferably used in the case of forming displays on the back side of the key tops. Except for transparency, the resin materials used for the back side cover 19 of the first embodiment can be similarly used as the material of the key tops. Especially preferred are ultraviolet curable liquid resins. The resins used for the key tops may have rubber elasticity. In particular, materials having rubber hardness A50 to D70 defined by JIS K6253 can be used. At rubber hardness larger than D70, thin key tops to be formed are likely to crack in the pressing operation while having hardness, resulting in reduction of its durability. At rubber hardness smaller than A50, the key tops are likely to be bent in the pressing operation and cannot therefore provide accurate tactile feel, resulting in the fear of the decrease in the pressing operability.

### Fifth Modification Common to Embodiment

The diffusion layers may be formed as display elements, and the light-shielding print layer may be formed as the background of the display element. This configuration eliminates formation of additional displays on the key tops. The diffusion layers function as the display elements, so that the display elements can directly reflect light guided inside the light guide sheet. As compared with a configuration in which the displays are illuminated with light reflected by the diffusion layers, this modification suppresses the loss of the illumination and therefore provides brightly luminous display elements.

### Sixth Modification Common to Embodiment

A planar illuminated key sheet may be provided without formation of the key tops. In the illuminated key sheet of each of the first to third embodiments, for example, the base sheet has the surface formed by the planar front sheet. In this configuration, a planar illuminated key sheet can be provided without formation of the key tops. The mask layers and the light-shielding print layer formed so as to have the same color can prevent the segments of the illumination areas from appearing, which can provide improved appearance. This configuration preferably has the displays as in the fifth modification.

The configurations of the embodiments and modifications may be combined or replaced with each other to the extent possible.

For example, although the illuminated key sheet 61 of the sixth embodiment has the reinforcing frame 69 as the back side cover, liquid resins may cover the back side of the reinforcing frame, as in the back side cover 19 of the first embodiment, to form the back side cover including the reinforcing frame and resin layer. Furthermore, the liquid resins may be replaced with the resin film such as the back side cover 59 of the fifth embodiment to form the back side cover including the reinforcing frame and the resin film. These configurations can provide the advantageous effects of the individual embodiments at the same time.

The illuminated key sheet 61′ of the first modification of the sixth embodiment may have the similar configuration. For instance, the back side cover formed in the first embodiment can fill the gap between the slits 15a and the reinforcing frame 69′. As compared with the case in which air space is formed between the metallic frame and the end face of the light guide sheet, this configuration can enhance the efficiency of the reflection by the reinforcing frame, which can further enhance brightness.

### REFERENCE SIGNS LIST

1 Display layer
2 Adhesive layer
3 LED (internal light source)
4 Smooth surface
5 Rough surface
10 Key top (depressing operation portions)
11 Illuminated key sheet (first embodiment)
12 Base sheet
13 Front sheet
14 Mask layer
15 Light guide sheet
   15a Slit
   15b Opening edge (opening edges of slits)
16 Diffusion layer
17 Transparent resin layer
18 Light-shielding print layer
19 Back side cover
   19a Penetration protrusion (end face cover)
   19b Pusher
21 Illuminated key sheet (second embodiment)
22 Base sheet
31 Illuminated key sheet (third embodiment)
32 Base sheet
39 Pusher
41 Illuminated key sheet (fourth embodiment)
42 Base sheet
43 Front sheet
44 Mask layer
51 Illuminated key sheet (fifth embodiment)
52 Base sheet
58 Light-shielding print layer
   58a End face cover
59 Back side cover
61 Illuminated key sheet (sixth embodiment)
62 Base sheet
69 Reinforcing frame (back side cover)
61′ Illuminated key sheet (modification of sixth embodiment)
62′ Base sheet
69′ Reinforcing frame (back side cover)
71 Illuminated key sheet (seventh embodiment)
72 Base sheet
75 Light guide sheet
   75a Slit
   75b Opening edge
   75c Space
   75d Adhesive layer
   75e Diffusion layer
79 Resin sheet
81 Illuminated key sheet (eighth embodiment)
82 Base sheet
91 Illuminated key sheet (ninth embodiment)
92 Base sheet
94 Mask layer
111 Illuminated key sheet (first modification of embodiments)
112 Base sheet
115 Light receiver
   115a Contact surface
   115b Accommodation cavity
   115c Inclined surface
121 Illuminated key sheet (second modification of embodiments)
122 Base sheet
125 Light guide sheet
   125a Slit
   125e Bridge

1. An illuminated key sheet comprising: a flexible base sheet; and a plurality of depressing operation portions formed on the flexible base sheet, wherein
the base sheet includes a light guide sheet having a slit and a plurality of illumination areas defined by the slit, and
the base sheet has a mask layer and a reinforcement, the mask layer at least covering the opening edge of the slit on the operation surface side of the light guide sheet to prevent light leakage from the slit to the operation surface side, and the reinforcement adhering to the light guide sheet to cover the slit.

2. The illuminated key sheet according to claim 1, wherein the base sheet has an end face cover at least covering part of the end face of the light guide sheet and has a light-shielding layer provided to the back side of the light guide sheet to prevent light from entering the light guide sheet, the end face forming the slit, and the back side being opposite to the operation surface side.

3. The illuminated key sheet according to claim 1, wherein the reinforcement includes a front sheet which adheres to the operation surface side of the light guide sheet, and the mask layer is formed on the front sheet.

4. The illuminated key sheet according to claim 1, wherein the mask layer extends to part of the end face of the light guide sheet, the end face forming the slit.

5. The illuminated key sheet according to claim 1, wherein the reinforcement includes a back side cover provided to the back side of the light guide sheet.

6. The illuminated key sheet according to claim 1, wherein the reinforcement includes the front sheet attached to the operation surface side of the light guide sheet and includes the back side cover provided to the back side of the light guide sheet, and the front sheet adheres to the back side cover inside the slit, the front sheet and the back side cover being formed by using a resin film.

7. The illuminated key sheet according to claim 5, wherein the back side cover adheres to the plurality of the illumination areas of the light guide sheet and extends so as to entirely cover the back side of the illumination areas.

8. The illuminated key sheet according to claim 5, wherein the back side cover is a reinforcing frame that suppresses a warp of the base sheet.

9. The illuminated key sheet according to claim 5, wherein the back side cover has a solid penetration protrusion which functions as the end face cover, the solid penetration protrusion filling the slit.

10. The illuminated key sheet according to claim 2, wherein the end face cover entirely covers the end face of the light guide sheet, the end face forming the slit.

11. An illuminated key sheet comprising: a flexible base sheet; and a plurality of depressing operation portions formed on the flexible base sheet, wherein
the base sheet includes a light guide sheet having a slit and a plurality of illumination areas defined by the slit, and
the base sheet has a mask layer which at least covers the opening edge of the slit on the operation surface side of the light guide sheet to prevent light leakage from the slit to the operation surface side, and
the hiding layer covers at least partially the operation surface side of the light guide sheet continuing into the opening edge.

12. The illuminated key sheet according to claim 11, wherein the base sheet includes a front sheet formed on the operation surface side of the light guide sheet so as to cover the slit, the front sheet adhering to the plurality of the illumination areas.

13. The illuminated key sheet according to claim 11, wherein the base sheet has an end face cover at least covering part of the end face of the light guide sheet, the end face forming the slit.

14. The illuminated key sheet according to claim 11, wherein the base sheet includes a light-shielding print layer provided to the back side of the light guide sheet to prevent light from entering the light guide sheet, the back side being opposite to the operation surface side.

15. The illuminated key sheet according to claim 1, wherein the light guide sheet has a bridge which connects the areas of the light guide sheet across the slit.

16. The illuminated key sheet according to claim 1, wherein a transparent resin layer is provided on the back side of the light guide sheet, and the light guide sheet and the transparent resin layer have smooth surfaces which contact each other.

17. The illuminated key sheet according to claim 16, the transparent resin layer is formed by using resin having a refractive index smaller than the refractive index of the light guide sheet.

18. The illuminated key sheet according to claim 8, wherein a reinforcing film is formed inside the slit.

19. The illuminated key sheet according to claim 11, wherein the light guide sheet has a bridge which connects the areas of the light guide sheet across the slit.

20. The illuminated key sheet according to claim 11, wherein a transparent resin layer is provided on the back side of the light guide sheet, and the light guide sheet and the transparent resin layer have smooth surfaces which contact each other.
